(19) United States
(12) Patent Application Publication
(10) Pub. No.: US 2009/0150890 A1
(43) Pub. Date: Jun. 11, 2009

(54) STRAND-BASED COMPUTING HARDWARE AND DYNAMICALLY OPTIMIZING STRANDWARE FOR A HIGH PERFORMANCE MICROPROCESSOR SYSTEM

(76) Inventor: Matt T. Yourst, Mountain View, CA (US)

Correspondence Address: Van Dyke Consulting (ST);Client: Strandera, 3343 Little Valley Rd, Sunol, CA, 94586, US

(21) Appl. No.: 12/331,425

(22) Filed: Dec. 9, 2008

Related U.S. Application Data
(63) Continuation-in-part of application No. PCT/US08/85990, filed on Dec. 8, 2008.
(60) Provisional application No. 61/012,741, filed on Dec. 10, 2007.

(51) Int. Cl. G06F 9/46

(52) U.S. Cl. 718/102

(57) ABSTRACT

Strand-based computing hardware and dynamically optimizing strandware are included in a high performance microprocessor system. The system operates in real time automatically and unobservably to parallelize single-threaded software into a plurality of parallel strands for execution by cores implemented in a multi-core and/or multi-threaded microprocessor of the system. The microprocessor executes a native instruction set tailored for speculative multithreading. The strandware directs hardware of the microprocessor to collect dynamic profiling information while executing the single-threaded software. The strandware analyzes the profiling information for the parallelization, and uses binary translation and dynamic optimization to produce native instructions to store in a translation cache later accessed to execute the produced native instructions instead of some of the single-threaded software. The system is capable of parallelizing a plurality of single-threaded software applications (e.g. application software, device drivers, operating system routines or kernels, and hypervisors).

### CROSS REFERENCE TO RELATED APPLICATIONS

Priority benefit claims for this application are made in the accompanying Application Data Sheet, Request, or Transmittal (as appropriate, if any). To the extent permitted by the type of the instant application, this application incorporates by reference for all purposes the following applications, all owned by the owner of the instant application:
U.S. Provisional Application (Application No. 61/012,741), filed Dec. 10, 2007, first named inventor M. Yourst, and entitled Speculative Multithreading Hardware and Dynamically Optimizing Hypervisor Software for a High Performance Microprocessor; and
PCT Application Serial No. PCT/U.S.08/85990 (Docket No. ST-08-01PCT), filed Dec. 8, 2008, first named inventor M. Yourst, and entitled Strand-Based Computing Hardware and Dynamically Optimizing Strandware for a High Performance Microprocessor System.

### BACKGROUND

1. Field

Advancements in computer processing are needed to provide improvements in performance, efficiency, and utility of use.

2. Related Art

Unless expressly identified as being publicly or well known, mention herein of techniques and concepts, including for context, definitions, or comparison purposes, should not be construed as an admission that such techniques and concepts are previously publicly known or otherwise part of the prior art. All references cited herein (if any), including patents, patent applications, and publications, are hereby incorporated by reference in their entireties, whether specifically incorporated or not, for all purposes.

### OVERVIEW

The invention may be implemented in numerous ways, including as a process, an article of manufacture, an apparatus, a system, and a computer readable medium (e.g. media in an optical and/or magnetic mass storage device such as a disk, or an integrated circuit having non-volatile storage such as flash storage). In this specification, these implementations, or any other form that the invention may take, may be referred to as techniques. The Detailed Description provides an exposition of one or more embodiments of the invention that enable improvements in performance, efficiency, and utility of use in the field identified above. The Detailed Description includes an Introduction to facilitate the more rapid understanding of the remainder of the Detailed Description. The Introduction includes Example Embodiments of one or more of systems, methods, articles of manufacture, and computer readable media in accordance with the concepts described herein. As is discussed in more detail in the Conclusions, the invention encompasses all possible modifications and variations within the scope of the issued claims.

### BRIEF DESCRIPTION OF DRAWINGS

FIG. 1A illustrates a system with strand-enabled computers each having one or more strand-enabled microprocessors with access to a strandware image, memory, non-volatile storage, input/output devices, and networking.

FIGS. 1B and 1C collectively illustrate conceptual hardware, strandware (software), and target software layers (e.g. subsystems) relating to a strand-enabled microprocessor.

FIGS. 2A, 2B, and 2C collectively illustrate an example of hardware executing a skipahead strand (such as synthesized by strandware), plotted against time in cycles versus core or interconnect. Sometimes the description refers to FIGS. 2A, 2B, and 2C collectively as FIG. 2.

FIG. 3 illustrates an example of nested loops, expressed in C code.

FIG. 4 illustrates a recursive function example.

FIG. 5 illustrates an embodiment of a Loop Profiling Counter (LPC).

FIG. 6 illustrates an embodiment of a Strand Execution Profiling Record (SEPR).

FIG. 7 illustrates an example of uops to generate a predicted parent strand live-out set, as reconstructed from SEPRs.

FIGS. 8A and 8B collectively illustrate an example of an optimized bridge trace (in SSA-form) corresponding to the live-out predicting uops illustrated in FIG. 7. Sometimes the description refers to FIGS. 8A and 8B collectively as FIG. 8.

FIG. 9 illustrates an example of a scheduled VLIW bridge trace corresponding to the bridge trace illustrated in FIGS. 8A and 8B.

FIG. 10 illustrates an example of a read-modify-write idiom in target (e.g. x86) code.

FIG. 11 illustrates an example of a read-modify-write idiom in uops corresponding to target code.

FIG. 12 illustrates an example of read-modify-write code instrumented for deferral.

FIG. 13 illustrates an embodiment of a deferred operation record (DOR).

FIG. 14 illustrates an example code sequence for “mem=max(mem* % rcx, % rax)”).

FIG. 15 illustrates an example uop sequence translated from the code sequence of FIG. 14.

FIG. 16 illustrates an example of a deferred instrumented version of the uop sequence of FIG. 15.

FIG. 17 illustrates an example of a custom deferral resolution handler for the instrumented sequence of FIG. 16.

FIG. 18 illustrates an example of C/C++ code using explicit hints.

### DETAILED DESCRIPTION

A detailed description of one or more embodiments of the invention is provided below along with accompanying figures illustrating selected details of the invention. The invention is described in connection with the embodiments. The embodiments herein are understood to be merely exemplary, the invention is expressly not limited to or by any or all of the embodiments herein, and the invention encompasses numerous alternatives, modifications, and equivalents. To avoid monotony in the exposition, a variety of word labels (including but not limited to: first, last, certain, various, further, other, particular, select, some, and notable) may be applied to separate sets of embodiments; as used herein such labels are expressly not meant to convey quality, or any form of preference or prejudice, but merely to conveniently distinguish among the separate sets. The order of some operations of disclosed processes is alterable within the scope of the invention. Wherever multiple embodiments serve to describe variations in process, method, and/or program instruction features, other embodiments are contemplated that in accordance with a predetermined or a dynamically determined criterion perform static and/or dynamic selection of one of a plurality of modes of operation corresponding respectively to a plurality of the multiple embodiments. Numerous specific details are set forth in the following description to provide a thorough understanding of the invention. The details are provided for the purpose of example and the invention may be practiced according to the claims without some or all of the details. For the purpose of clarity, technical material that is known in the technical fields related to the invention has not been described in detail so that the invention is not unnecessarily obscured.

### INTRODUCTION

The introduction is included only to facilitate the more rapid understanding of the Detailed Description; the invention is not limited to the concepts presented in the introduction (including explicit examples, if any), as the paragraphs of any introduction are necessarily an abridged view of the entire subject and are not meant to be an exhaustive or restrictive description. For example, the introduction that follows provides overview information limited by space and organization to only certain embodiments. There are many other embodiments, including those to which claims will ultimately be drawn, discussed throughout the balance of the specification.

### Terms

The disclosure herein uses various terms. Examples of at least some of the terms follow.

An example of a thread is a software abstraction of a processor, e.g. a dynamic sequence of instructions that share and execute upon the same architectural machine state (e.g. software visible state). Some (so-called single-threaded) processors are enabled to execute one sequence of instructions on one architectural machine state at a time. Some (so-called multithreaded) processors are enabled to execute N sequences of instructions on N architectural machine states at a time. In some systems, an operating system creates, destroys, and schedules threads on available hardware resources.

In some embodiments, all threads are with respect to instructions and machine state that are in accordance with a single instruction set architecture (ISA). In some embodiments, some threads are in accordance with a first ISA, and other threads are in accordance with a second ISA. In some embodiments, some threads are in accordance with a native ISA (such as a native uop ISA), and other threads are in accordance with an external ISA (such as an x86 ISA). In some embodiments, some threads are in accordance with a publicly documented ISA (such as an x86 ISA) that one or more of various types of target software (e.g. application software, device drivers, operating system routines or kernels, and hypervisors) are written in, whereas other threads are in accordance with an internal instruction set designated for embodiment-specific uses within a processor. In some embodiments having binary translation based processors (such as Transmeta Efficeon and IBM Daisy/BOA), a first ISA is publicly documented (such as x86 and PowerPC, respectively), whereas a second ISA is proprietary (such as a VLIW-based ISA). In some binary translation embodiments, hardware of the processor is enabled to directly execute a proprietary ISA that binary translation software is written in, while not enabled to directly execute a publicly documented ISA. In some embodiments, some threads are in accordance with an ISA used for strandware, and other threads are in accordance with an ISA used for one or more of various types of target software (e.g. application software, device drivers, operating system routines or kernels, and hypervisors).

An example of a strand is an abstraction of processor hardware, e.g. a dynamic sequence of uops (e.g. micro-operations directly executable by the processor hardware) that share and execute upon the same machine state. For some strands the machine state is architectural machine state (e.g. architectural register state), and for some strands the machine state is not visible to software (e.g. renamed register state, or performance analysis registers). In some embodiments, a strand is visible to an operating system if machine state of the strand includes all architectural machine state of a thread (e.g. general-purpose registers, software accessible machine state registers, and memory state). In some embodiments, a strand is not visible to an operating system, even if machine state of the strand includes all architectural machine state of a thread.

An example of an architectural strand is a strand that is visible to an operating system and corresponds to a thread. An example of a speculative strand (e.g. a successor strand) is a strand that is not visible to the operating system. Certain strands contain only hidden machine state (e.g. prefetch or profiling strands).

In some embodiments, strandware and/or processor hardware create, destroy, and schedule strands. In some embodiments, forks create strands. Some forks are in response to a uop (of a parent strand) that specifies a target address (for the strand created by the fork) and optionally specifies other information (e.g., data to be inherited as machine state). When the uop of the (parent) strand is executed, a speculative successor strand is optionally created.

In various embodiments and/or usage scenarios, strands are destroyed in response to one or more of a kill uop, an unrecoverable error, and completion of the strand (e.g. via a join). In some embodiments and/or usage scenarios, strands are joined in response to a join uop. In some embodiments and/or usage scenarios, strands are joined in response to a set of hardware-detected conditions (e.g. a current execution address matching a starting address of a successor strand). In various embodiments, strands are destroyed by any combination of strandware and/or hardware (e.g. in response to processing a uop or automatically in response to a predetermined or programmatically specified condition). In some usage scenarios, strands are joined by merging some machine state of a parent architectural strand with machine state of a successor strand of the parent; then the parent is destroyed and the child strand optionally becomes an architectural strand.

An example of a Virtual Central Processing Unit (VCPU) is a software visible execution context that is enabled for an operating system to schedule one thread onto at any particular time. In some embodiments, a computer system presents one or more VCPUs to the operating system. Each VCPU implements a register portion of the architectural machine state, and in some embodiments, architectural memory state is shared between one or more VCPUs. Conceptually each VCPU comprises one or more strands dynamically created by strandware and/or hardware. For each VCPU, the strands are arranged into a first-in first-out (FIFO) queue, where the next strand to commit is the architectural strand of the VCPU, and all other strands are speculative.

### EXAMPLE EMBODIMENTS

In concluding the introduction to the detailed description, what follows is a collection of example embodiments, including at least some explicitly enumerated as “ECs” (Example Combinations), providing additional description of a variety of embodiment types in accordance with the concepts described herein; the examples are not meant to be mutually exclusive, exhaustive, or restrictive; and the invention is not limited to these example embodiments but rather encompasses all possible modifications and variations within the scope of the issued claims.

EC1. A computer system, comprising:

strand construction means for dynamic-profiling-directed partitioning of selected software into a plurality of strands;

execution means for execution of the selected software, wherein the execution means is enabled to perform processing of at least part of the selected software via a plurality of simultaneously executing strands of the plurality of strands;

analysis means for identifying one or more latent dependencies corresponding to respective cross strand operations occurring between the plurality of simultaneously executing strands and aliasing to one or more respective memory locations;

deferral means for removing the one or more latent dependencies via replacing the respective cross strand operations with one or more respective deferred operations;

resolution means for evaluating each of the deferred operations performed by the plurality of simultaneously executing strands;

wherein the identifying and the replacing are enabled to operate dynamically during the execution of the selected software; and

wherein with respect to execution of the at least part of the selected software, results realized from the processing via the plurality of simultaneously executing strands are identical to architecture-specified results for strictly sequential processing.

EC2. The computer system of EC1, wherein each of the respective deferred operations records one or more information fields respectively required by the replaced respective cross strand operations.

EC3. The computer system of EC1, wherein the replacing prevents a reduction in strand parallelism otherwise expected from the respective cross strand operations aliasing to the one or more respective memory locations.

EC4. The computer system of EC1, wherein the identifying and the replacing are enabled to operate without requiring one or more of compiler support and ahead-of-execution profiling.

EC5. The computer system of EC1, wherein:

the aliased memory locations are potentially read and written at run time in a non-predetermined order by the plurality of simultaneously executing strands; and

the cross strand operations comprise reading data from the one or more aliased memory locations, performing one or more computations that consume the data as inputs, and writing results of the one or more computations back into the one or more aliased memory locations.

EC6. The computer system of EC1, wherein the cross strand operations comprise operations from one or more of: single instructions, simple multiple instruction sequences, complex sequences of multiple instructions, single uops, simple multiple uop sequences, and complex sequences of multiple uops.

EC7. The computer system of EC1, wherein the replacing is performed via a static replacement in the selected software.

EC8. The computer system of EC1, wherein the replacing is performed dynamically.

EC9. The computer system of EC1, wherein the type of the one or more information fields are one or more of the information field types comprising: input operand, type of operation, and memory address.

EC10. The computer system of EC1, further comprising: thread-state coalescing means for hardware-assisted joining of two strands of the plurality of simultaneously executing strands.

EC11. The computer system of EC1, wherein the plurality of simultaneously executing strands comprises an oldest architectural strand and a speculative successor strand of the oldest architectural strand, and the evaluating of the deferred operations performed by the oldest architectural strand and the speculative successor strand is carried out when the oldest architectural strand joins the speculative successor strand.

EC12. The computer system of EC1, wherein the evaluating of the deferred operations performed by at least one of the plurality of simultaneously executing strands is carried out on demand.

EC13. The computer system of EC1, wherein the plurality of simultaneously executing strands comprises two speculative strands, and the evaluating is carried out when the two speculative strands join.

EC14. The computer system of EC1, wherein the selected software comprises one or more of: one or more parts of one or more programs from a single userspace, one or more parts of programs from multiple userspaces, one or more parts of an operating system of the computer system, one or more parts of a hypervisor of the computer system.

EC15. A method, comprising:

dynamic-profiling-directed partitioning of selected software into a plurality of strands;

executing the selected software via a plurality of simultaneously executing strands of the plurality of strands;

during the executing, identifying one or more cross strand operations occurring between the plurality of simultaneously executing strands and establishing respective latent dependencies corresponding to respective aliasing to one or more memory locations, and removing the respective latent dependencies via replacing the identified cross strand operations with one or more respective deferred operations;

the plurality of simultaneously executing strands performing at least some of the deferred operations; and

for each deferred operation performed by the plurality of simultaneously executing strands, computing results identical to results architecture-specification predicted for strict sequential execution.

EC16. The method of EC15, further comprising: for each cross strand operation replaced, recording in each of the respective deferred operations one or more information fields required by the replaced cross strand operations.

EC17. The method of EC15, wherein for each cross strand operation replaced, the replacing insures that a realizable parallelism of the plurality of simultaneously executing strands is not reduced by the replaced cross strand operation.

EC18. The computer system of EC15, further comprising: enabling the identifying and the replacing to operate without requiring one or more of compiler support and ahead-of-execution profiling.

EC19. The method of EC15, wherein:

the aliased memory locations are potentially read and written at run time in a non-predetermined order by the plurality of simultaneously executing strands; and

the cross strand operations comprise reading data from the one or more aliased memory locations, performing one or more computations that consume the data as inputs, and writing results of the one or more computations back into the one or more aliased memory locations.

EC20. The method of EC15, wherein the cross strand operations comprise operations from one or more of: single instructions, simple multiple instruction sequences, complex sequences of multiple instructions, single uops, simple multiple uop sequences, and complex sequences of multiple uops.

EC21. The method of EC15, further comprising: performing the replacing via a static replacement in the software.

EC22. The method of EC15, further comprising: performing the replacing dynamically at run time.

EC23. The method of EC15, wherein the type of the one or more information fields are one or more of the information field types comprising: input operand, type of operation, and memory address.

EC24. The method of EC15, wherein the plurality of simultaneously executing strands comprises an oldest architectural strand and a speculative successor strand of the oldest architectural strand, and further comprising performing the computing of the results when the oldest architectural strand joins the speculative successor strand.

EC25. The method of EC15, further comprising: performing the computing of the results on demand.

EC26. The method of EC15, wherein the plurality of simultaneously executing strands comprises two speculative strands, and further comprising: performing the computing of the results when the two speculative strands join.

EC27. A computer system, comprising:

a first strandware task means for binary translation, comprising a first strandable strandware-code portion;

a second strandware task means for dynamic optimization, comprising a second strandable strandware-code portion;

a third strandware task means for profiling, comprising a third strandable strandware-code portion;

a fourth strandware task means for constructing stands, comprising a fourth strandable strandware-code portion, wherein the constructed strands are derived from the strandable strandware-code portions and one or more user-code portions; and

an execution means for executing strands, the execution means enabled to simultaneously execute a plurality of the constructed strands.

EC28. The computer system of EC27, wherein the computing system is enabled to simultaneously execute two or more strands respectively derived from two or more of the strandable strandware-code portions.

EC29. The computer system of EC27, wherein the plurality of simultaneously executing strands are performing at least portions of a plurality of strandware tasks comprising two or more of binary translation, dynamic optimization, profiling, and strand construction.

EC30. The computer system of EC27, wherein the computing system is enabled to simultaneously execute a strand derived from one of the strandable strandware-code portions and a strand derived from one of the one or more user-code portions.

EC31. The computer system of EC27, wherein the plurality of simultaneously executing strands are executed via the use of one or more resource types from the group of resource types comprising a plurality of cores, a plurality of functional units, and a plurality of context switching structures.

EC32. A method, comprising:

binary translating via a first strandable strandware-code portion;

dynamically optimizing via a second strandable strandware-code portion;

profiling via a third strandable strandware-code portion;

constructing stands via a fourth strandable strandware-code portion, wherein the constructed strands are derived from the strandable strandware-code portions and one or more user-code portions; and

simultaneously executing a plurality of the constructed strands.

EC33. The method of EC32, wherein the plurality of simultaneously executing strands comprise a plurality of strands respectively derived from a plurality of the strandable strandware-code portions.

EC34. The method of EC32, wherein the plurality of simultaneously executing strands are performing at least portions of a plurality of strandware tasks comprising two or more of binary translation, dynamic optimization, profiling, and strand construction.

EC35. The method of EC32, wherein the plurality of simultaneously executing strands comprise a strand derived from one of the strandable strandware-code portions and a strand derived from one of the one or more user-code portions.

EC36. The method of EC32, wherein the plurality of simultaneously executing strands are executed via the use of one or more resource types from the group of resource types comprising a plurality of cores, a plurality of functional units, and a plurality of context switching structures.

EC37. A computer system, comprising:

strand construction means for dynamic-profiling-directed partitioning of selected software into a plurality of strands;

execution means for execution of the selected software, wherein the execution means is enabled to perform processing of at least part of the selected software via a plurality of simultaneously executing strands of the plurality of strands;

means for dynamically observing and dynamically identifying at least one strand-behavior-change of at least one respective behavior-changed-strand of the simultaneously executing strands; and

means for dynamically responding to the identification of the at least one strand-behavior-change by performing a predetermined action.

EC38. The computer system of EC37, wherein the simultaneously executing strands are of a plurality of strand types, and further wherein the predetermined action comprises dynamically responding to the identification of the at least one strand-behavior-change by dynamically transforming the at least one respective behavior-changed-strand from being a member of a first of the plurality of strand types to being a member of a second of the plurality of strand types.

EC39. The computer system of EC38, wherein the plurality of strand types comprise a speculative strand type capable of committing results into the user visible state and a prefetch strand type that does not commit to the architectural state.

EC40. The computer system of EC37, wherein the at least one identified strand-behavior-change comprises aborts exceeding a predetermined threshold frequency of occurrence and the predetermined action comprises splitting the respective behavior-changed-strand into sub-strands.

EC41. The computer system of EC37, wherein the at least one identified behavior change comprises aborts exceeding a predetermined threshold frequency of occurrence and the predetermined action comprises disabling the respective behavior-changed-strand.

EC42. The computer system of EC37, wherein the predetermined action comprises regenerating a bridge trace used to predict live-ins of the respective behavior-changed-strand.

EC43. A computer system, comprising:

strand construction means for dynamic-profiling-directed partitioning of selected software into a plurality of strands;

execution means for execution of the selected software, wherein the execution means is enabled to perform processing of at least part of the selected software via a plurality of simultaneously executing strands of the plurality of strands, and wherein each of the simultaneously executing strands has a strand type of a plurality of strand types; and

strand adaptation means for dynamic-profiling-directed altering of the strand type of at least one of the simultaneously executing strands.

EC44. A method, comprising:

executing selected software;

during the executing, dynamically profiling the selected software;

during the executing and as directed by the profiling, dynamically partitioning the selected software into a plurality of strands;

during the executing, processing of at least part of the selected software via a plurality of simultaneously executing strands of the plurality of strands; and

during the profiling, dynamically observing and dynamically identifying at least one strand-behavior-change of at least one respective behavior-changed-strand of the simultaneously executing strands; and

dynamically responding to the identification of the at least one strand-behavior-change by performing a predetermined action.

EC45. The method of EC44, further comprising:

during the executing and as directed by the profiling, associating each of the plurality of strands with a strand type of a plurality of strand types; and

during the performing, dynamically altering the strand type of at least one of the simultaneously executing strands.

EC46. The method of EC45, wherein the plurality of strand types comprise a speculative strand type capable of committing results into the user visible state and a prefetch strand type that does not commit to the architectural state.

EC47. The method of EC44, further comprising:

when the at least one identified strand-behavior-change comprises aborts exceeding a predetermined threshold frequency of occurrence, the performing comprising splitting the respective behavior-changed-strand into sub-strands.

EC48. The method of EC44, further comprising:

when the at least one identified behavior change comprises aborts exceeding a predetermined threshold frequency of occurrence, the performing comprising disabling the respective behavior-changed-strand.

EC49. The method of EC44, further comprising:

the performing comprising regenerating a bridge trace used to predict live-ins of the respective behavior-changed-strand.

### Multi-Core, Multithreading, and Speculation

### Microprocessors, Multi-Core, and Multithreading

Performance of microprocessors has grown since introduction of the first microprocessor in the 1970s. Some microprocessors have deep pipelines and/or operate at multi-GHz clock frequencies to extract performance with a single processor out of sequential programs. Software engineers write some programs as a sequence of instructions and operations that a microprocessor is to execute sequentially and/or in order. Various microprocessors attempt to increase performance of the programs by operating at an increased clock frequency, executing instructions out-of-order (OOO), executing instructions speculatively, or various combinations thereof. Some instructions are independent of other instructions, thus providing instruction level parallelism (ILP), and therefore are executable in parallel or OOO. Some microprocessors attempt to exploit ILP to improve performance and/or increase utilization of functional units of the microprocessor.

Some microprocessors (sometimes referred to as multi-core microprocessors) have more than one “core” (e.g. processing unit). Some single chip implementations have an entire multi-core microprocessor, in some instances with shared cache memory and/or other hardware shared by the cores. In some circumstances, an agent (e.g. strandware) partitions a computing task into threads, and some multi-core microprocessors enable higher performance by executing the threads in parallel on the of cores of the microprocessor. Some microprocessors (such as some multi-core microprocessors) have cores that enable simultaneous multithreading (SMT).

Some microprocessors that are compatible with an x86 instruction set (such as some microprocessors from Intel and AMD) have a relatively few replications of (relatively complex) OOO cores. Some microprocessors (such as some microprocessors from Sun and IBM) have relatively many replications of (relatively simple) in-order cores. Some server and multimedia applications are multithreaded, and some microprocessors with relatively many cores perform relatively well on the multithreaded software.

Some multi-core microprocessors perform relatively well on software that has relatively high thread level parallelism (TLP). However, in some circumstances, some resources of some multi-core microprocessors are unused, even when executing software that has relatively high TLP. Software engineers striving to improve TLP use mechanisms that coordinate access to shared data to avoid collisions and/or incorrect behavior, mechanisms that ensure smooth and efficient parallel interlocking by reducing or avoiding interlocking between threads, and mechanisms that aid debugging of errors that appear in multithreaded implementations.

With respect to some problem domains, some compilers automatically recognize seemingly sequential operations of a thread as divisible into parallel threads of operations. Some sequences of operations are indeterminate with respect to independence and potential for parallel execution (e.g. portions of code produced from some general-purpose programming languages such as C, C++, and Java). Software engineers sometimes use some special-purpose programming languages (or parallel extensions to general-purpose programming languages) to express parallelism explicitly, and/or to program multi-core and/or multithreaded microprocessors or portions thereof (such a graphics processing unit or GPU). Software engineers sometimes express parallelism explicitly for some scientific, floating-point, and media processing applications.

### Speculative Multithreading Fundamentals

In some usage scenarios and/or embodiments, speculative multithreading, thread level speculation, or both enable more efficient automatic parallelization. In a speculative multithreading microprocessor system, compiler software, strandware, firmware, microcode, or hardware units of the microprocessor, or any combination thereof, conceptually insert one or more instances of a selected one of a plurality of types of fork instructions into various locations of a program. Conceptually, the system begins executing a (new) successor strand at a target address inside the program, and manages propagation of register values (and optionally memory stores) to the successor strand from the (parent) strand the successor strand was forked from. The propagation is either via stalling the successor strand until the values arrive, or by predicting the values and later comparing the predicted values with values generated by the parent strand. The system creates the successor strand as a subset of a thread (e.g., the successor strand receives a subset of architectural state from the thread and/or the successor strand executes a subset of instructions of the thread). The fork instruction specifies the target address as a Register for Instruction Pointer (RIP). The system implements strand management functions (e.g. forking and joining) in various embodiments via various hardware elements (such as logic units, finite state machines, micro-coded engines, and other circuitry), various software elements (such as instructions executable by a core, firmware, microcode, strandware, and other software agents), or various combinations thereof.

The speculative multithreading microprocessor system processes join operations in (original) program order. Consider a parent strand that forks a successor strand to a target address. A join occurs when the parent strand executes up to the target address (sometimes referred to as an intersection). In some circumstances, the successor strand has completed (in parallel with the parent strand), and the successor strand is immediately ready to join. At a join point, the system performs various consistency checks, such as ensuring (potentially predicted) live-out register values the parent strand propagated to the successor strand match actual values of the parent strand at the join point. The checks guarantee that execution results with the forked strand are identical to results without the forked strand. If any of the checks fail, then the system takes appropriate action (such as by discarding results of the forked strand). After a join of parent and successor strands, the parent strand terminates. The system then makes the context of the parent strand available for reuse. The successor strand becomes the architecturally visible instance of the thread that the system created the strand for. The system makes current architectural state of the successor strand (e.g. registers and memory) observable to other threads within the microprocessor (such as a thread on another core), other agents of the microprocessor (such as DMA), and devices outside the microprocessor.

Some speculative multithreading systems implement a nested strand model. For example, a parent strand P forks a primary successor strand S, and recursively forks sub-strands P1, P2, and P3. The system nests the sub-strands within the parent strand. The sub-strands execute independently of S and each other. P joins with S conditionally upon completion all of the sub-strands of P. In contrast, other speculative multithreading systems implement a strictly program ordered non-nested speculative multithreading model. For example, each parent strand P has at most one forked successor strand S outstanding at any time. P forks no more strands until either P intersects with S (resulting in a join) or S no longer executes. In some circumstances, implementing a non-nested model uses less and/or simpler hardware than implementing a nested model. Some usage scenarios with unmodified sequential programs are suitable for use with a non-nested model implementation.

Some speculative multithreading systems use memory versioning. For example, a successor strand that (speculatively) stores to a particular memory location uses a private version of the location, observable to strands that are later in program order than the successor strand, but not observable to other strands (that are earlier in program order than the successor strand). The system makes the speculative stores observable (in an atomic manner) to other agents when joining the successor and the parent strands. The other agents include strands other than the successor (and later) strands, other threads or units (such as DMA) of the microprocessor, devices external to the microprocessor, and any element of the system that is enabled to access memory. In some circumstances, the system accumulates several kilobytes of speculative store data before a join. Consider a situation where a parent strand (later in program order) is to write a memory location and a successor strand of the parent strand is to read the memory location. If the successor strand reads the memory location before the parent strand writes the memory location, then the system aborts the successor strand. The disclosure sometimes refers to the aforementioned situation as cross-strand memory aliasing. In some scenarios, the system reduces (or avoids) occurrences of cross-strand memory aliasing by choosing fork points resulting in little (or no) cross-strand memory aliasing.

Conceptually, the system arranges the strands belonging to a particular thread in a program ordered queue, similar to individual instructions of a reorder buffer (ROB) in an out-of-order processor. The system processes strand forks and joins in program order. The strand at the head of the queue is the architectural strand, and is the only strand enabled to execute a join operation, while subsequent strands are speculative strands. In some scenarios, strands contain complex control flow (such as branches, calls, and loops) independent of other strands. In some circumstances, strands execute thousands of instructions between creation (at a fork point) and termination (at a join point). In some situations, relatively large amounts of strand level parallelism are available over the thousands of instructions even with relatively few outstanding strands.

Some systems use speculative multithreading for a variety of purposes (such as prefetching), while some systems use speculative multithreading only for prefetching. For example, a particular strand encounters a cache miss while executing a load instruction that results in an access to a relatively slow L3 cache or main memory. The system forks a prefetch strand from the load instruction, and stalls the particular strand. The system continues to stall the particular strand while waiting for return data for the (missing) load. Unlike some other types of strands, a missing load does not block a prefetch strand, but rather provides a predicted or a dummy value without waiting for the miss to be satisfied. In various usage scenarios, prefetch strands enable prefetching for loads that have addresses calculated independently of an initial missing load, enable prefetching for loads related to processing a linked list, enable tuning or pre-correcting a branch predictor, or any combination thereof. A prefetch strand forked in response to a missing load is aborted when the missing load is satisfied e.g. since the prefetch strand used predicted or dummy values and is not suitable for joining to another strand.

In some circumstances, performance improvements obtained via speculative multithreading depend on particular choices of fork and join points. In some embodiments, the system places fork points at control quasi-independent points, e.g. points that all possible execution paths eventually reach. For example, with respect to a current iteration of a loop, the system forks a strand starting at the iteration immediately following the current iteration, thus enabling the two strands to execute wholly or partially in parallel. For another example (e.g. when iterations of the loop are interdependent), the system forks a strand to execute code that follows a loop end, enabling iterations of the loop to execute in one strand while the code after the loop executes in another strand. For another example, the system forks a strand to start executing code that follows a return from a called function (optionally predicting a return value of the called function), enabling the called function and the code following the return to execute wholly or partially in parallel via two strands. In various embodiments, fork points are inserted by one or more of: automatically by a compiler and/or strandware (optionally based at least in part on profiling execution, analyzing dynamic program behavior, or both), automatically by hardware, and manually by a programmer.

Various embodiments of speculative multithreading are automatic and/or unobservable. Some of the automatic and/or unobservable speculative multithreading embodiments are applicable to all types of target software (e.g. application software, device drivers, operating system routines or kernels, and hypervisors) without any programmer intervention. (Note that the description sometimes refers to target software as target code, and the target code is comprised of target instructions.) Some of the automatic and/or unobservable speculative multithreading embodiments are compatible with industry-standard instruction sets (such as an x86 instruction set), industry-standard programming tools or languages (such as C, C++, and other languages), and industry-standard general-purpose computer systems (such as servers, workstations, desktop computers, and notebook computers).

### System Architecture

### System of Strand-Enabled Computers

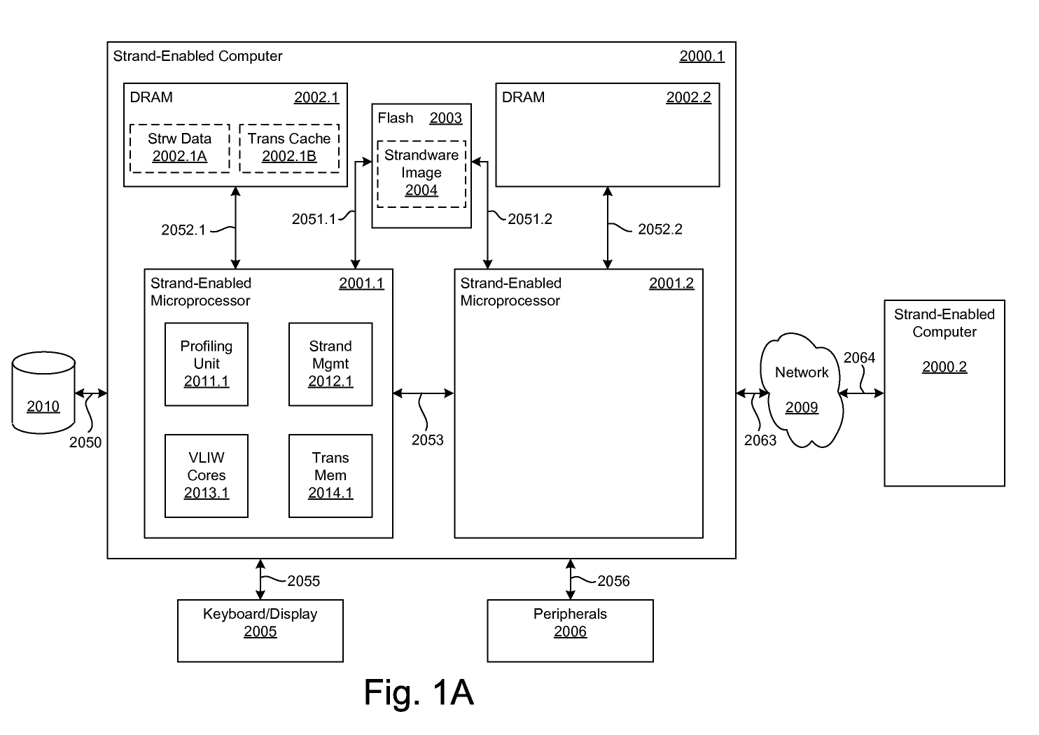

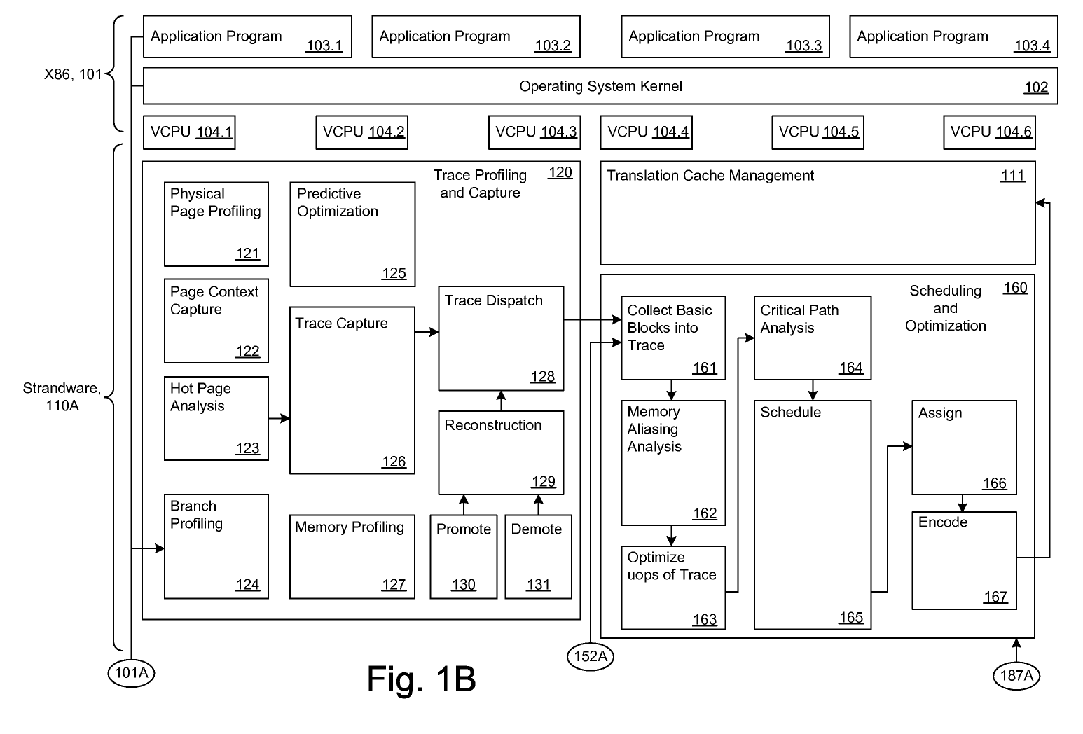

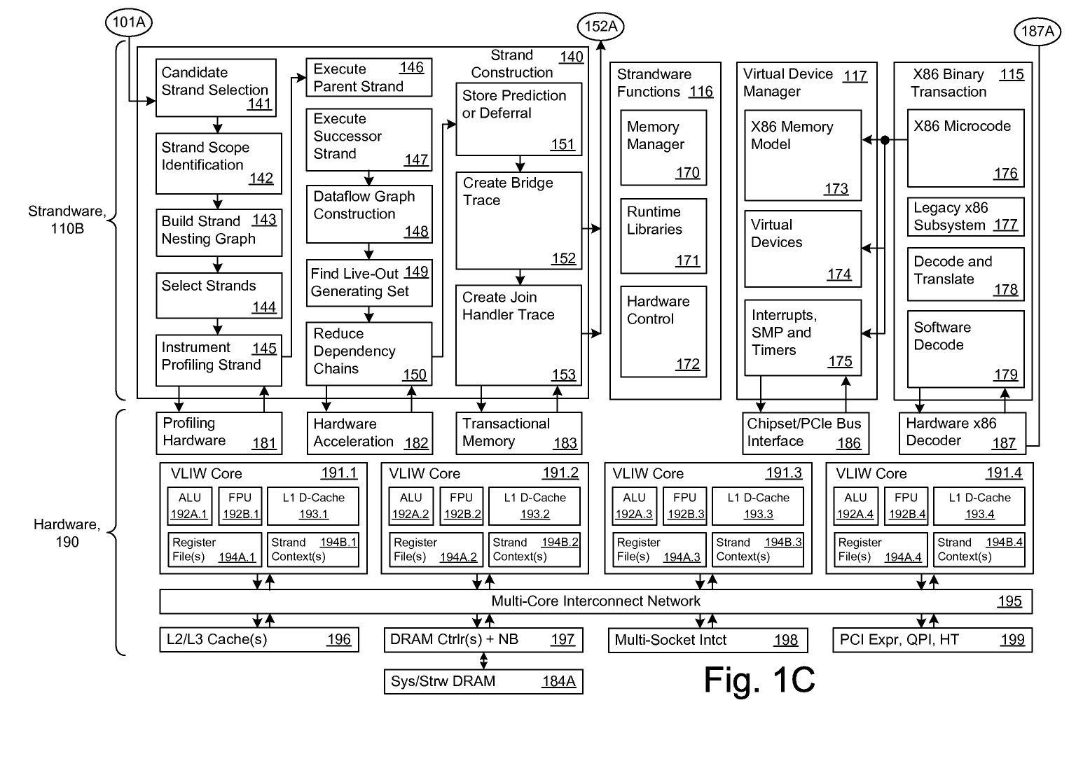

FIG. 1A illustrates a system with strand-enabled computers, each having one or more strand-enabled microprocessors with access to a strandware image, memory, non-volatile storage, input/output devices, and networking. Conceptually the system executes the strandware to observe (via hardware assistance) and analyze dynamic execution of (e.g. x86) instructions of target software (e.g. application, driver, operating system, and hypervisor software). The strandware uses the observations to determine how to partition the x86 instructions into a plurality of strands suitable for parallel execution on VLIW core resources of the strand-enabled microprocessors. The strandware translates the partitioned instructions into operations (e.g. micro-operations or uops), and then arranges the operations into bundles for efficient execution on the VLIW core resources. The strandware stores the bundles in a translation cache for later use (e.g. as one or more strand images). The translation optionally includes augmentation with additional operations having no direct correspondence to the x86 instructions (e.g. to improve performance or to enable parallel execution of the strands). The system subsequently arranges for execution of and executes the stored bundles (e.g. strand images instead of portions of the x86 instructions) to attempt to improve performance. In some embodiments, one or more of the observing, analyzing, partitioning, and the arranging for and execution of are with respect to traces of instructions.

The figure illustrates Strand-Enabled Computers 2000.1-2000.2, enabled for communication with each other via couplings 2063, 2064, and Network 2009. Strand-Enabled Computer 2000.1 couples to Storage 2010 via coupling 2050, Keyboard/Display 2005 via coupling 2055, and Peripherals 2006 via coupling 2056.

The Network is any communication infrastructure that enables communication between the Strand-Enabled Computers, such as any combination of a Local Area Network (LAN), Metro Area Network (MAN), Wide Area Network (WAN), and the Internet. Coupling 2063 is compatible with, for example, Ethernet (such as 10 Base-T, 100 Base-T, and 1 or 10 Gigabit), optical networking (such as Synchronous Optical NETworking or SONET), or a node interconnect mechanism for a cluster (such as Infiniband, MyriNet, QsNET, or a blade server backplane network). The Storage element is any non-volatile mass-storage element, array, or network of same (such as flash, magnetic, or optical disk(s), as well as elements coupled via Network Attached Storage or NAS and/or Storage Array Network or SAN techniques). Coupling 2050 is compatible with, for example, Ethernet or optical networking, Fibre Channel, Advanced Technology Attachment or ATA, Serial ATA or SATA, external SATA or eSATA, as well as Small Computer System Interface or SCSI.

The Keyboard/Display element is conceptually representative of any type of one or more of alphanumeric, graphical, or other human input/output device(s) (such as a combination of a QWERTY keyboard, an optical mouse, and a flat-panel display). Coupling 2055 is conceptually representative of one or more couplings enabling communication between the Strand-Enabled Computer and the Keyboard/Display. In one example, one element of coupling 2055 is compatible with a Universal Serial Bus (USB) and another element is compatible with a Video Graphics Adapter (VGA) connector. The Peripherals element is conceptually representative of any type of one or more input/output device(s) usable in conjunction with the Strand-Enabled Computer (such as a scanner or a printer). Coupling 2056 is conceptually representative of one or more couplings enabling communication between the Strand-Enabled Computer and the Peripherals.

In various embodiments (not illustrated), various elements illustrated as external to the Strand-Enabled Computer (such as Storage 2010, Keyboard/Display 2005, and Peripherals 2006), are included in the Strand-Enabled Computer. In some embodiments, one or more of Strand-Enabled Microprocessors 2001.1-2001.2 include hardware to enable coupling to elements identical or similar in function to any of the elements illustrated as external to the Strand-Enabled Computer. In various embodiments, the included hardware is compatible with one or more particular protocols, such as one or more of a Peripheral Component Interconnect (PCI) bus, a PCI eXtended (PCI-X) bus, a PCI Express (PCI-E) bus, a HyperTransport (HT) bus, and a Quick Path Interconnect (QPI) bus. In various embodiments, the included hardware is compatible with a proprietary protocol used to communicate with an (intermediate) chipset that is enabled to communicate via any one or more of the particular protocols.

In some embodiments, the Strand-Enabled Computers are identical to each other, and in other embodiments the Strand-Enabled Computers vary according to differences relating to market and/or customer requirements. In some embodiments, the Strand-Enabled Computers operate as server, workstation, desktop, notebook, personal, or portable computers.

As illustrated, Strand-Enabled Computer 2000.1 includes two Strand-Enabled Microprocessors 2001.1-2001.2 coupled respectively to Dynamic Random Access Memory (DRAM) elements 2002.1-2002.2. The Strand-Enabled Microprocessors communicate with Flash 2003 respectively via couplings 2051.1-2051.2 and with each other via coupling 2053. Strand-Enabled Microprocessor 2001.1 includes Profiling Unit 2011.1, Strand Management unit 2012.1, VLIW Cores 2013.1, and Transactional Memory 2014.1.

In some embodiments, the Strand-Enabled Microprocessors are identical to each other, and in other embodiments the Strand-Enabled Microprocessors vary according to differences relating to market and/or customer requirements. In various embodiments, a Strand-Enabled Microprocessor is implemented in any of a single integrated circuit die, a plurality of integrated circuit dice, a multi-die module, and a plurality of packaged circuits.

For brevity, the following description is with respect to one of the illustrated Strand-Enabled Microprocessors. Operation of the other Strandware-Enabled Strand-Enabled Microprocessors is similar. Strandware-Enabled Microprocessor 2001.1 exits a reset state (such as when performing a cold boot) and begins fetching and executing instructions of strandware from a code portion of Strandware Image 2004 contained in Flash 2003. The execution of the instructions initializes various strandware data structures (e.g. Strandware Data 2002.1A and Translation Cache 2002.1B, illustrated as portions of DRAM 2002.1). The initializing includes copying all or any subsets of the code portion of the Strandware Image to a portion of the Strandware Data, and setting aside regions of the Strandware Data for strandware heap, stack, and private data storage.

Then the Strand-Enabled Microprocessor begins processing x86 instructions (such as x86 boot firmware contained, in some embodiments, in the Flash), subject to the aforementioned observing (via at least in part Profiling Unit 2011.1) and analyzing. The processing is further subject to the aforementioned partitioning into strands for parallel execution, translating into operations and arranging into bundles corresponding to various strand images, and storage into translation cache (such as Translation Cache 2002.1B). The processing is further subject to the aforementioned subsequent arranging for and execution of the stored bundles (via at least in part Strand Management unit 2012.1, VLIW Cores 2013.1, and Transactional Memory 2014.1).

Partitioning of elements illustrated in the figure is illustrative only, as there are other embodiments with other partitioning. For example, various embodiments include all or any portion of the Flash and/or the DRAM in a Strand-Enabled Microprocessor. For another example, various embodiments include storage for all or any portion of the Strandware Data and/or the Translation Cache in a Strand-Enabled Microprocessor (such as in one or more Static Random Access Memories or SRAMs on an integrated circuit die). For another example, in some embodiments, Strandware Data 2002.1A and Translation Cache 2002.1B are contained in different DRAMs (such as one in a first Dual In-line Memory Module or DIMM and another in a second DIMM). For another example, various embodiments store all or any portion of the Strandware Image on Storage 2010.

### Massively Multithreaded Hardware and Strandware

FIGS. 1B and 1C collectively illustrate conceptual hardware, strandware (software), and target software layers (e.g. subsystems) relating to a strand-enabled microprocessor (such as either of Strand-Enabled Microprocessors 2001.1-2001.2 of FIG. 1A). The figure is conceptual in nature, and for brevity, the figure omits various control and some data couplings.

Hardware Layer 190 includes one or more independent cores (e.g. instances of VLIW Cores 191.1-191.4), each core enabled to process in accordance with one or more hardware thread contexts (e.g. stored in instances of Register Files 194A.1-194A.4 and/or Strand Contexts 194B.1-194B.4), suitable for simultaneous multithreading (SMT) and/or hardware context switching. The microprocessor is enabled to execute instructions in accordance with an ISA. The microprocessor includes speculative multithreading extensions and enhancements, such as hardware to enable processing of fork and join instructions and/or operations, inter-thread and inter-core register propagation logic and/or circuitry (Multi-Core Interconnect Network 195), Transactional Memory 183 enabling memory versioning and conflict detection capabilities, Profiling Hardware 181, and other hardware elements that enable speculative multithreading processing. In the illustrated embodiment, the microprocessor also includes a multi-level cache hierarchy (e.g. instances of L1 D-Caches 193.1-193.4 and L2/L3 Caches 196), one or more interfaces to mass memory and/or hardware devices external to the microprocessor (DRAM Controllers and Northbridge 197 coupled to external System/Strandware DRAM 184A), a socket-to-socket system interconnect (Multi-Socket System Interconnect 198) useful, e.g. in a computer with a plurality of microprocessors (each microprocessor optionally including a plurality of cores), and interfaces/couplings to external hardware devices (Chipset/PCIe Bus Interface 186 for coupling via external PCI Express, QPI, HyperTransport 199).

Strandware Layers 110A and 110B (sometimes referred to collectively as Strandware Layer 110) and (x86) Target Software Layer 101 are executed at least in part by all or any portion of one or more cores included in and/or coupled to the microprocessor (such as any of the instances of VLIW Cores 191.1-191.4 of FIG. 1C). The strandware layer is conceptually invisible to elements of the target software layer, conceptually operating transparently “underneath” and/or “at the same level” as the target software layer. The target software layer includes Operating System Kernel 102 and programs (illustrated as instances of Application Programs 103.1-103.4), illustrated as being executed “above” the operating system kernel. In some embodiments and/or usage scenarios, the target software layer includes a hypervisor program (e.g. similar to VMware or Xen) that manages a plurality of operating system instances.

In various embodiments, the strandware layer enables one or more of the following capabilities:
Virtualization of the microprocessor hardware to present one or more virtual CPUs (e.g. instances of VCPUs 104.1-104.6) and associated Virtual Devices 174 to the target software. The VCPUs appear to execute a target instruction set the Target Software Layer 101 is coded in. The VCPUs are dynamically mapped onto native cores (e.g. instances of VLIW Cores 191.1-191.4 that are enabled to execute a native instruction set) and strand contexts (retained, e.g. in one or more instances of Register Files 194A.1-194A.4 and/or Strand Contexts 194B.1-194B.4) of the microprocessor.
Instrumentation, profiling, and analysis of the target software while the target software is executed, at least in part to identify opportunities for splitting (sequential) streams of instructions into speculatively multithreaded strands. For example, the system partitions respective sequential streams of instructions executed by one or more of the VCPUs into multiple speculatively multithreaded strands.
Insertion of instructions and/or code sequences into the target software, based on the analysis, to invoke various speculative multithreading hardware units of the microprocessor to fork and join strands, to predict and/or propagate live-in values to strands, to manage memory versioning and conflicts between strands, and to fork prefetch strands.
Optimization of target software to accelerate speculative multithreading performance, such as rescheduling instructions to generate critical strand live-ins values earlier in time, deferring and/or reordering operations that inhibit parallelism to break or eliminate cross-strand dependencies and remove memory aliasing, and removing redundant operations within prefetch strands.
Maintenance of a repository of modified, instrumented, and/or optimized code (e.g. via Translation Cache Management 111) so that the code in the repository is invisible to target code and is available to be invoked by the strandware in place of original target code (e.g. a portion of the target code before being modified, instrumented, or optimized).
To process any internal exceptions or errors that are a result of any of the modifications, instrumentations, and optimizations (such as speculative multithreading) that would otherwise not have occurred when executing the target software. In some circumstances, the processing of the internal exceptions or errors includes re-optimizing and/or disabling optimizations that decrease performance.
Providing an optional mechanism to target code for providing the strandware with hints, such as potentially profitable fork points, synchronization points, likely cross-strand aliasing points, and other optimization information.

### Binary Translation and Dynamic Optimization

In some embodiments, the microprocessor hardware is enabled to execute an internal instruction set that is different than the instruction set of the target software. The strandware, in various embodiments, optionally in concert with any combination of one or more hardware acceleration mechanisms, performs dynamic binary translation (such as via x86 Binary Translation 115) to translate target software of one or more target instruction sets (such as an x86-compatible instruction set, e.g., the x86-64 instruction set) into native micro-operations (uops). The hardware acceleration mechanisms include all or any portion of one or more of Profiling Hardware 181, Hardware Acceleration unit 182, Transactional Memory 183, and Hardware x86 Decoder 187. The microprocessor hardware (such as instances of VLIW Cores 191.1-191.4) is enabled to directly execute the uops (and in various embodiments, the microprocessor hardware is not enabled to directly execute instructions of one or more of the target instruction sets). The translations are then stored in a repository (e.g. via Translation Cache Management 111) for rapid recall and reuse (e.g. as strand images), thus eliminating translating again, at least under some circumstances.

In various embodiments, the microprocessor is enabled to access (such as by being coupled or attached to) a relatively large memory area. The system implements the memory area via a dedicated DRAM module (included in or external to the microprocessor, in various embodiments) or alternatively as part of a reserved area in external System/Strandware DRAM 184A that is invisible to target code. The memory area provides storage for various elements of the strandware (such as one or more of code, stack, heap, and data) and, in some embodiments, all or any portion of a translation cache (e.g. as managed by Translation Cache Management 111), as well as optionally one or more buffers (such as speculative multithreading temporary state buffers). When the microprocessor first boots (such as by performing a cold boot), the strandware code is copied from a flash ROM into the memory area (such as into the dedicated DRAM module or a reserved portion of external System/Strandware DRAM 184A), that the microprocessor then fetches native uops from. After the strandware initializes the microprocessor (such as via Hardware Control 172) and internal data structures of the strandware, the strandware begins execution of boot firmware and/or operating system kernel boot code (coded in one or more of the target instruction sets) using binary translation (such as via x86 Binary Translation 115), similar to a conventional hardware based microprocessor without a binary translation layer.

In some usage scenarios, using the strandware to perform binary translation and/or dynamic optimization offers advantages compared to adding speculative multithreading instructions to the target instruction set. In some circumstances, the binary translation and/or dynamic optimization enable simplifying hardware of each core, for example by removing and/or reducing hardware for decoding the target instruction sets (such as Hardware x86 Decoder 187) and hardware for out-of-order execution. In some embodiments, the removed and/or reduced hardware is conceptually replaced with one or more VLIW (Very Long Instruction Word) microprocessor cores (such as instances of instances of VLIW Cores 191.1-191.4). The VLIW cores, for example, execute pre-scheduled bundles of uops, where all of the uops of a bundle execute (or begin execution) in parallel (e.g. on a plurality of functional units such as instances of ALUs 192A.1-192A.4 and FPUs 192B.1-192B.4). In various embodiments, the VLIW cores lack one or more of relatively complicated decoding, hardware-based dependency analysis, and dynamic out of order scheduling. The VLIW cores optionally include local storage (such as instances of L1 D-Caches 193.1-193.4 and Register Files 194A.1-194A.4) and other per-core hardware structures for efficient processing of instructions.

In some usage scenarios and/or embodiments, the VLIW cores are small enough to enable one or more of packing more cores into a given die area, powering more cores within a given power budget, and clocking cores at a higher frequency than would otherwise be possible with complex out-of-order cores. In some usage scenarios and/or embodiments, semantically isolating the VLIW cores from the target instruction sets via binary translation enables efficient encoding of uop formats, registers, and various details of the VLIW core relevant to efficient speculative multithreading, without modifying the target instruction sets.

### Role of Strandware Dynamic Optimization Software

A trace construction subsystem of the strandware layer (such as Trace Profiling and Capture 120), when executed by the microprocessor, collects and/or organizes translated uops into traces (e.g. from uops of a sequence of translated basic blocks having common control flow paths through the target code). The strandware performs relatively extensive optimizations (such as via Optimize 163), using a variety of techniques. Some of the techniques are similar in scope to what an optimizing compiler having access to source code performs, but the strandware uses dynamically measured program behavior collected during profiling (such as via one or more of Physical Page Profiling 121, Branch Profiling 124, Predictive Optimization 125, and Memory Profiling 127) to guide at least some optimizations. For instance, loads and stores to memory are selectively reordered (such as a function of information obtained via Memory Aliasing Analysis 162) to initiate cache misses as early as possible. In some embodiments, the selective reordering is based at least in part on measurements (such as made via Memory Profiling 127) of loads and stores that reference a same address. In some usage scenarios and/or embodiments, the selective reordering enables relatively aggressive optimizations over a scope of hundreds of instructions. Each uop is then scheduled (such as by insertion into a schedule by Schedule each uop 165) according to when input operands are to be available and when various hardware resources (such as functional units) are to be free. In some embodiments (such as some embodiments having functionality as illustrated by Encode VLIW-like bundles 167), the scheduling attempts to pack up to four uops into each bundle. Having a plurality of uops in a bundle enables a particular VLIW core (such as any of VLIW Cores 191.1-191.4) to execute the uops in parallel when the scheduled trace is later executed. Finally, the optimized trace (having VLIW bundles each having one or more uops) is inserted into a repository (such as via Translation Cache Management 111) as all or part of a strand image. In some embodiments, the hardware only executes native uops from traces stored in the translation cache, thus enabling continuous reuse of optimization work performed by the strandware. In some usage scenarios and/or embodiments, traces are successively re-optimized through a series of increasingly higher performance optimization levels, each level being relatively more expensive to perform (such as via Promote 130), depending, for example, on how frequently a trace is executed.

In some embodiments, the dynamic optimization software enables some relatively aggressive optimizations via use of atomic execution. In some circumstances, instances of the relatively aggressive optimizations would be “unsafe” without atomic execution, e.g. incorrect modifications to architectural state would result. An example of atomic execution is treating a group of uops (termed a commit group) as an indivisible unit with respect to modifications to architectural state. A trace optionally comprises one or more commit groups. If all of the uops of a commit group complete correctly (such as without any exceptions or errors), then changes are made to the architectural state in accordance with results of all of the uops of the commit group. Under other circumstances, the results of all of the uops of the commit group are discarded, and there are no changes made to the architectural state with respect to the uops of the commit group. For example, in the event of an exception detected with respect to a uop of a commit group (such as a page fault or a branch that follows a different path than the path that the trace was originally generated along), a rollback occurs, and all results generated by all of the uops of the commit group are discarded. After a rollback, in some embodiments and/or usage scenarios, the microprocessor and/or the strandware re-executes instructions corresponding to the uops of the commit group in original program order (and optionally without one or more optimizations) to pinpoint a source of the exception. Co-pending U.S. patent application Ser. No. 10/994,774 entitled “Method and Apparatus for Incremental Commitment to Architectural State” discloses other information regarding dynamic optimization and commit groups.

The hardware and the software operating in combination enable, in some embodiments and/or usage scenarios, benefits similar to an out-of-order dynamically scheduled microprocessor, such as by extracting fine-grained parallelism within a single strand via relatively aggressive VLIW trace scheduling and optimization. The hardware and the software perform the fine-grained parallelism extracting, in various embodiments, while relatively efficiently reordering and interleaving independent strands to cover memory latency stalls, similar to an out-of-order microprocessor. In some circumstances, the hardware and the software enable relatively efficient scaling across many cores and/or threads, enabling an effective issue width of potentially hundreds of uops per clock.

### Multithreaded Dynamic Optimization

In some embodiments having a massively multi-core and/or multithreaded microprocessor, the dynamic optimization software is implemented to relatively efficiently use resources of the plurality of cores and/or threads. For example, one or more of Trace Profiling and Capture 120, Strand Construction 140, Scheduling and Optimization 160, and x86 Binary Translation 115 are pervasively multithreaded at one or more levels, enabling a reduction, elimination, or effective hiding of some or all overhead associated with binary translation and/or dynamic optimization. The microprocessor executes the dynamic optimization software in a background manner so that forward progress in executing target code (e.g. through optimized code from a translation cache) is not impeded. Various embodiments implement one or more mechanisms to enable the background manner of executing the dynamic optimization software. For example, the microprocessor and/or the strandware dedicate portions of resources (such as one or more cores in a multi-core microprocessor embodiment) specifically to executing the dynamic optimization software. The dedication is either permanent, or alternatively transient and/or dynamic, e.g. when the portions of resources are available (such as when target code explicitly places unused VCPUs into an idle state). For another example, priority control mechanisms of one or more cores enable strandware threads (mapped, e.g. to target-visible VCPUs) to share the cores and associated cache(s) with little or no observable performance degradation (for instance, by using slack cycles created by stalled target threads executing in accordance with a target ISA).

### Hardware and Strandware Implementation

In various embodiments, elements illustrated in FIG. 1A correspond to all or portions of functionality illustrated in FIGS. 1B and 1C. For example, in some embodiments, DRAM 2002.1 of FIG. 1A corresponds to external System/Strandware DRAM 184A of FIG. 1C, and Translation Cache Management 111 manages Translation Cache 2002.1B. For another example, in some embodiments, VLIW Cores 2013.1 of FIG. 1A correspond to one or more of VLIW Cores 191.1-191.4 of FIG. 1C, Transactional Memory 2014.1 of FIG. 1A corresponds to Transactional Memory 183 of FIG. 1C, and Profiling Unit 2011.1 of FIG. 1A corresponds to Profiling Hardware 181 of FIG. 1C. For another example, in some embodiments Strand Management unit 2012.1 of FIG. 1A corresponds to control logic coupled to one or more of Register Files 194A.1-194A.4 and/or Strand Contexts 194B.1-194B.4 of FIG. 1C.

For another example of the correspondence between elements of FIGS. 1A, 1B, and 1C, in some embodiments, Strandware Image 2004 of FIG. 1A has an initial image of all or any portion of Strandware Layers 110A and 110B of FIGS. 1B and 1C. For another example, in some embodiments, Strand-Enabled Microprocessor 2001.1 of FIG. 1A implements functions as exemplified by Hardware Layer 190 of FIG. 1C.

In various embodiments, all or any portion of Chipset/PCIe Bus Interface 186, Multi-Socket System Interconnect 198, and/or PCI Express, QPI, HyperTransport 199 of FIG. 1C, implement all or any portion of interfaces associated with couplings 2050, 2055, 2056, 2063, 2051.1, and 2053 of FIG. 1A. In various embodiments, all or any portion of Chipset/PCIe Bus Interface 186 and/or PCI Express, QPI, HyperTransport 199, operating in conjunction with Interrupts, SMP, and Timers 175 of FIG. 1C, implement all or any portion of all or any portion of Keyboard/Display 2005 and/or Peripherals 2006 of FIG. 1A. In various embodiments, all or any portion of DRAM Controllers and Northbridge 197 of FIG. 1C, implement all or any portion of interfaces associated with coupling 2052.1 of FIG. 1A.

### Speculative Multithreading Model

The speculative multithreading of various embodiments is for use on unmodified target code where an appearance of fully deterministic program ordered execution is always maintained. In some embodiments, the speculative multithreading provides a strictly program ordered non-nested speculative multithreading model where each parent strand has at most one successor strand at any given time. If a parent strand P forks a first child strand S1 and then attempts to fork a second child strand S2 before joining with S1 and/or before S1 terminates, then the fork of S2 is ineffective (e.g. the fork of S2 is suppressed such as by treating the fork of S2 as a no-operation or as a NOP). If a parent strand attempts a fork and there are not enough resources (e.g. there are no free thread contexts) to complete the fork, then the fork is suppressed or alternatively the forked thread is blocked until resources become available, optionally depending on what type of fork the fork is.

In some embodiments, the microprocessor is enabled to execute in accordance with a native uop instruction set that includes a variety of uops, features, and internal registers usable to fork strands, control interactions between strands, join strands, and abort (e.g. kill) strands. In some embodiments, the variety of uops includes:
fork.type target,inherit directs the microprocessor to create a new successor strand S of parent strand P. The microprocessor (via any combination of hardware and software elements) maps the successor strand to a specific core and thread of the microprocessor in accordance with one or more strandware and/or hardware defined policies. A particular VCPU executing a f ork uop of a parent strand owns the successor strand (along with the parent strand). Execution of the successor strand begins at a target address specified by the target parameter (either in terms of a native uop address within a strandware address space or as a target code RIP). The inherit parameter is used as an indication of which registers will be modified by the parent strand after executing the fork operation, and which registers should be copied (inherited) to the successor strand (see the section “Skipahead Strands” located elsewhere herein). The type parameter specifies one of several different strand types for the successor strand (such as a fine-grained skipahead strand, a fully speculative multithreaded strand, a prefetch strand, or strands having other semantics or purposes). The fork uop provides an output value that is a strand ID. The strand ID is an identifier (that is globally unique at least within a same VCPU) associated with the successor strand that specifies the program order of the successor strand relative to all other strands that are associated with the particular VCPU owning both the parent and the successor strands.
kill.cmptype.cc ra, rb, T directs the microprocessor to eliminate one or more strands. More specifically, when executed within parent strand P, kill recursively aborts successor strand S (if any) of P and all successor strands of S (if any). Execution of the kill uop compares register operands ra and rb via specified ALU operation cmptype (e.g. kill.sub or kill.and) thus generating a result, and then checks specified condition code cc (e.g. less-than-or-equal) of the result. If the specified condition is true, the strand scope identifier T matches the strand scope identifier of the associated fork uop, and the nested fork depth is zero, then successor strands of parent strand P are killed. See the sections “Strand Scope Identification” and “Nested Strands” located elsewhere herein for further disclosure.
wait.type [object] directs the microprocessor to stall execution pending a specified condition. More specifically, when executed within strand S, wait causes execution of strand S to wait on a specified condition (and optionally on a specified object such as a memory address) before proceeding. For example, in some embodiments, the microprocessor is enabled to wait until a strand is architectural (e.g. non-speculative), to wait for a specific memory location to be written, to wait until a successor strand completes, and to wait until a parent strand reaches some state.
join directs the microprocessor to block execution of a speculative successor strand associated with a parent strand, until the parent strand joins with the successor strand. The join uop is executed by the strandware when a particular strand is unable to make forward progress while speculative.
Uops optionally include a propagate bit that instructs the hardware to transmit results of the uop (in a parent strand) to a successor strand of the parent strand. See the section “Skipahead Strands” located elsewhere herein for further disclosure relating to the propagate bit.

In some embodiments, some or all of the functionality of the aforementioned uops is implemented by executing a plurality of other uops, performing writes to internal machine state registers, invoking a separate non-uop-based hardware mechanism in an optionally automatic manner, or any combination thereof.

In various usage scenarios where a parent strand forks a speculative successor strand, there are several reasons for the successor strand to wait or stop execution (e.g. halt or suspend) and wait for the parent strand to join the successor strand. For example, if an exception occurs in a speculative strand, in some cases the exception indicates a mis-speculation or a situation where it is not productive for the parent strand to have forked the successor strand. For another example, a speculative strand attempts a particular operation that results in an exception since the particular operation is restricted for use only in a (non-speculative) architectural strand. Instances of the restricted operations optionally include accessing an I/O device (such as via PCI Express, QPI, HyperTransport 199), reading or writing particular memory regions (such as uncacheable memory), entering a portion of strandware that is limited to executing non-speculatively, or attempting to use a deferred operation result.

When a parent strand intersects with a waiting successor strand and if the parent verifies that all live-outs of the parent match the live-ins of the successor, then an exception of the successor strand is “genuine”. The exception is genuine in the sense that the exception is not a side effect of incorrect speculation and thus the microprocessor treats the exception in an architecturally visible manner. In various cases, when execution of the successor strand resumes, the successor strand immediately vectors based on the exception (such as into the operating system kernel) to process the exception (e.g. a page fault). In some cases, when execution of the successor strand resumes, execution continues without errors, since the successor strand is now architectural (non-speculative).

The microprocessor joins strands in program order, and each VCPU owns one or more of the strands. The most up-to-date architectural strand represents architectural state of the VCPU owning the strand. The microprocessor makes the architectural state available for observation outside of the owning VCPU (e.g. via a committed store to memory). The microprocessor is enabled to freely move the most up-to-date architectural strand between cores within the microprocessor, and meanwhile the owning VCPU appears to execute continuously (observed, for example, by an operating system kernel executed with respect to the owning VCPU).

### Speculative Multithreading Strategies

The microprocessor hardware and the microprocessor strandware (software) enable speculative multithreading on several levels with progressively wider scopes:
A prefetch strand (see the section “Prefetch Strands” located elsewhere herein) is optionally automatically forked when a strand stalls on a relatively long latency cache operation (e.g. a cache miss that is satisfied from main memory). A prefetch strand attempts to fetch data that is expected to be used into one or more caches and/or attempts to prime one or more branch predictors with appropriate data, before the data is used, for example before the data is accessed by the (parent) strand the prefetch strand was forked from. In some circumstances, a prefetch strand is active for several hundred cycles. In some embodiments, the system provides for any type of strand to fork a prefetch strand, as long as the forking strand has not forked another strand (thus preventing scenarios where a particular strand has more than one successor strand). In some embodiments, the system provides for any type of strand to fork a prefetch strand, even when the forking strand has forked another strand (leading to scenarios where a particular strand has more than one successor strand). In some embodiments, the hardware has logic to selectively activate or suppress creation of prefetch strands in accordance with one or more software and/or strandware controllable prefetching policies.
A skipahead strand (see the section “Skipahead Strands” located elsewhere herein) is forked by a parent strand when strandware determines the parent strand is relatively likely to stall on a particular instruction (e.g. a load that relatively frequently encounters a cache miss). Alternatively, a skipahead strand is forked so the skipahead strand begins executing after a relatively highly predictable final branch (e.g. a branch that has a correct prediction rate greater than a predetermined and/or programmable threshold). A skipahead strand blocks until the parent strand provides live-ins the skipahead strand depends on, for example, values for live-outs are transmitted to the skipahead strand (where a subset of the live-outs of the parent strand are live-ins of the skipahead strand) as the parent strand generates the live outs. The transmitted live-outs optionally include registers and/or memory locations.
A Speculative Strand Threading (SST) strand (see the section “Speculative Strand Threading (SST)” located elsewhere herein) is forked based on strandware dynamically (and optionally statically) inferring control flow structures and idioms. The structures and idioms include iteration constructs (e.g. loops), calls and returns (e.g. of subroutines, functions, procedures, and libraries), and control flow joins (e.g. in a conditional block a common join point reached by both “if” and “else” paths). An SST strand contains one or more instruction sequences (e.g. basic blocks, traces, commit groups, or other quanta of instructions). Dynamic control flow changes occur in some scenarios at the end of each instruction sequence to determine the next instruction sequence for the strand to execute. Control flow changes within an SST strand (unlike some other strand types) occur independently of control flow within the successor strands of the SST strand. The control flow changes within the SST strand relatively infrequently invalidate the successor strands. In some situations, the system selectively changes an SST strand to a prefetch strand. In some circumstances, an SST strand is active for tens or hundreds of thousands of cycles.
A profiling strand (see the section “Instrumentation for Profiling” located elsewhere herein) is used, in some embodiments, during the construction of SST strands to gather cross-strand forwarding data. With respect to other strands, a profiling strand is executed serially (e.g. in program order) rather than in parallel with the parent strand of the profiling strand.

### Prefetch Strands

In some circumstances of strand execution, the execution encounters stalling events (e.g., a cache miss to main memory) that would otherwise block progress. In response, the microprocessor optionally forks a prefetch strand while stalling the strand encountering the stalling event. The microprocessor allocates the (new) prefetch strand (in some embodiments, on the same core as the parent strand, but in a different strand context), such that the prefetch strand starts with the architectural state (register and memory) of the parent strand. The prefetch strand continues executing until delivery of information to the stalled (parent) strand enables the stalled strand to resume processing (e.g., data for the cache miss is delivered to the stalled strand). Then the microprocessor (e.g. elements of Hardware Layer 190) automatically destroys the prefetch strand and unblocks the stalled strand. In some embodiments, the microprocessor has logic to selectively activate or suppress creation of prefetch strands in accordance with one or more software and/or strandware controllable prefetching policies. For example, strandware configures the microprocessor to fork a prefetch strand when an L1 miss encountered by a strand results in a main memory access, and to stall the strand when an L1 miss results in an L2 or L3 hit.

In some circumstances of executing a load, the prefetch strand encounters a relatively long latency cache miss (such as a miss that led to the forking of the prefetch strand). If so, then instead of blocking, the load delivers (in the context of the prefetch strand) an ‘ambiguous’ placeholder value distinguished (e.g. by an ‘ambiguous bit’) from all other data values delivered by loads (such as all data values that are obtainable via a cache hit). The prefetch strand continues executing, using the ambiguous value for a result of the load. When a uop has at least one input operand of the ambiguous value (sometimes referred to as the “uop having an ambiguous input”), the uop propagates the ambiguous indication as a result for the uop (sometimes referred to as “uop outputs an ambiguous value”). The microprocessor executes a branch having an ambiguous input as if a predicted destination of the branch matches the actual destination of the branch. When a prefetch strand executes a store, the prefetch strand allocates a new cache line or temporary memory buffer element visible (e.g. observable and controllable) only by the prefetch strand, to prevent the parent strand from observing the store. In some embodiments, if a store writes an ambiguous value (e.g. into a cache), then the destination of the store receives the ambiguous value (e.g. affected bytes in one or more cache lines of the cache are marked as ambiguous). Subsequent loads of the destination receive the ambiguous value, thus propagating the ambiguous value. In various usage scenarios, the propagating of the ambiguous value enables avoiding prefetching unneeded data (e.g. when loading a pointer) and/or avoiding what would otherwise be incorrectly or inefficiently updating a branch predictor (e.g. when loading a branch condition).

In some embodiments, the microprocessor has logic to configure conditions and thresholds for loads encountering cache misses to return an ambiguous result in lieu of stalling a prefetch strand. For example, strandware configures the microprocessor to produce ambiguous values only for cache misses resulting in a main memory access, and to stall for other cache misses.

Prefetch strands, in various usage scenarios (such as integer and/or floating-point code), make data available before use by a parent strand (reducing or eliminating cache misses) and/or prime a branch predictor (reducing or eliminating mispredictions). Various embodiments use prefetch strands instead of (or in addition to) hardware prefetching.

In some circumstances where a prefetch strand is forked from a parent strand, the prefetch strand executes for several hundred cycles while the parent strand is waiting for a cache miss (such as when this miss is satisfied from main memory that is implemented, e.g., as DRAM). In some usage scenarios and/or embodiments, a system enables a prefetch strand to make forward progress for a relatively significant portion of the time a parent strand is waiting. For example, strandware constructs one or more traces for use in prefetch strands, and the traces optionally exclude uops with certain properties. E.g., the strandware optionally excludes uops that have no contribution to memory address generation. E.g., the strandware optionally excludes uops only used to verify relatively easily predicted branches. E.g., with respect to a trace within a particular prefetch strand, the strandware optionally excludes uops that store to memory a value that is not read (or is relatively unlikely to be read) within the prefetch strand. For yet another example, the strandware optionally excludes uops that load data that is already present (or relatively likely to be present) in a cache before execution of the uop. E.g., the strandware optionally excludes uops having properties that render the uops irrelevant to prefetching.

In some embodiments and/or usage scenarios, the microprocessor attempts to execute a prefetch strand relatively far ahead of a (waiting) parent strand, given available time. For example, the strandware attempts to minimize (by eliminating or reducing) uops in a prefetch trace, leaving only uops that are on one or more critical paths to execution of particular loads. The particular loads are, e.g., loads that relatively frequently result in a cache miss, loads that result in a cache miss with a relatively long latency to fill, or any combination thereof. In some embodiments, the strandware, in conjunction with the hardware (such as cache miss performance counters), collects and maintains profiling data structures used to determine the particular loads, such as by collecting information about delinquent loads. When optimizing a prefetch trace, the strandware optionally operates to reduce dataflow graphs that produce target addresses of the particular loads.

### Skipahead Strands

### Skipahead Multithreading Model

A profiling subsystem of the strandware layer (such as Trace Profiling and Capture 120 of FIG. 1B), when executed by the microprocessor, identifies selected traces as candidates for skipahead speculative multithreading. In some embodiments and/or usage scenarios, the system uses skipahead strands for traces that have a relatively highly predictable terminal branch (such as an unconditional branch, a loop instruction branch, or a branch that the system has predicted relatively successfully). The system optionally selects candidates based on one or more characteristics. An example characteristic is relatively low static Instruction Level Parallelism (ILP), such as due to relatively many NOPs. Another example characteristic is a relatively low dynamic ILP (such as having loads that relatively frequently stall, resulting in dynamic schedule gaps that are relatively difficult to observe statically). Another example characteristic is a potential for parallel issue that is greater than what a single core is capable of providing.

Skipahead speculative multithreading is effective in some usage scenarios having traces that contain entire loop iterations and/or where there are relatively few dependencies between loop iterations. Skipahead speculative multithreading is effective in some usage scenarios having calls and returns that are not candidates for inline expansion into a single trace. Skipahead speculative multithreading, in some usage scenarios and/or embodiments, yields performance levels similar to an ROB-based out-of-order core (but with relatively less hardware complexity). In some skipahead speculative multithreading circumstances, a successor strand skips several hundred instructions ahead of a start of a trace. Performance improvements effected by skipahead speculative multithreading (such as achieved by relatively high or maximum overlap) depend, in some situations, on relatively accurate prediction of a start address of a successor and data independence.

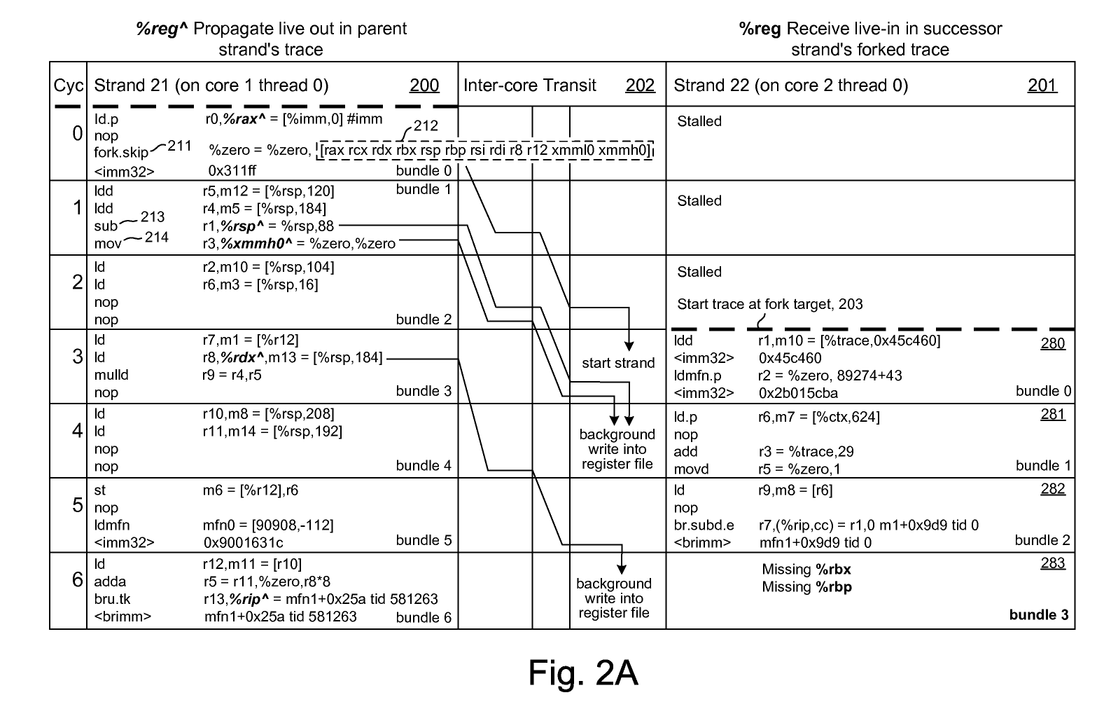

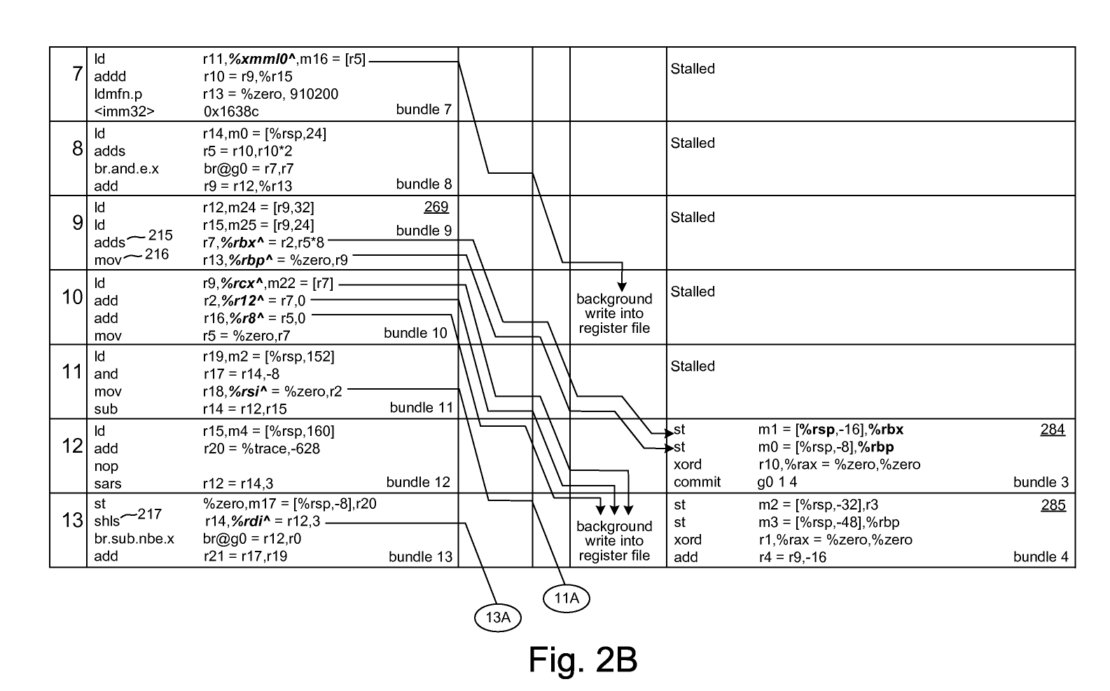

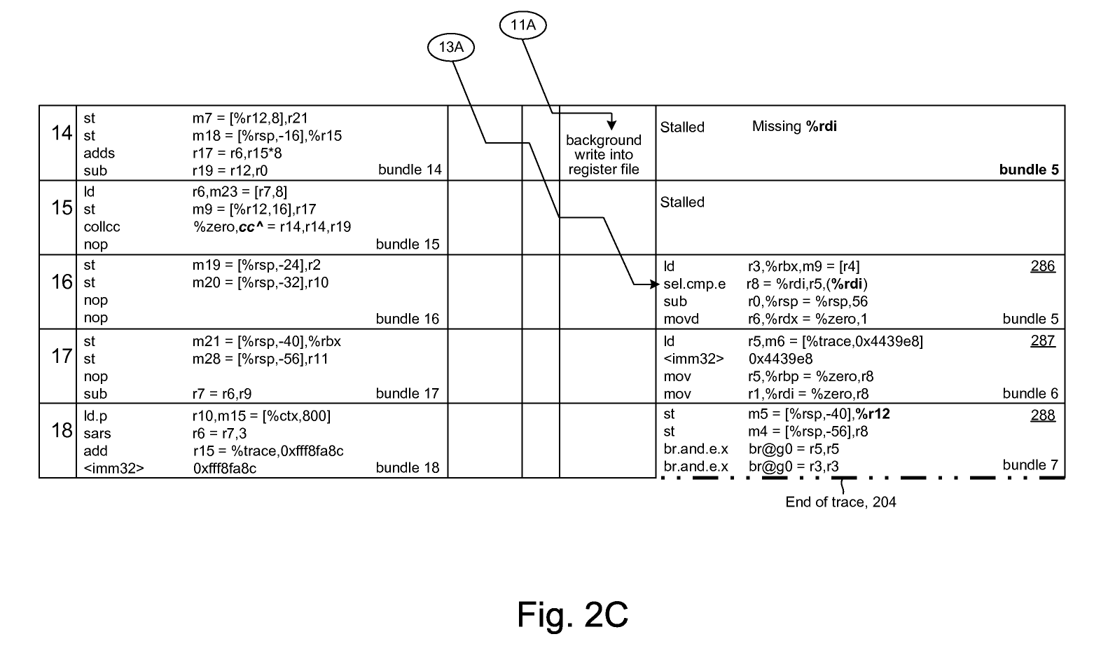

FIG. 2 illustrates an example of hardware executing a skipahead strand (such as synthesized by strandware), plotted against time in cycles versus core or interconnect. In the description, the term “skipahead strand” refers to execution (as a strand) of the target code (or a binary translated version thereof), where the skipahead strand begins execution at the next instruction (or binary translated equivalent) executed (in some circumstances) after the end of the terminal trace of a parent strand. For each skipahead strand, a code generator of the strandware layer (such as one or more elements of Scheduling and Optimization 160 of FIG. 1B and/or Strand Construction 140 of FIG. 1C) inserts a fork.skip uop into the terminal trace of the parent strand. The “terminal trace” of a strand refers to the final trace executed by the strand before the strand reaches its join point. When the system executes the fork.skip uop, the system forks a new (e.g. successor or child) strand as the skipahead strand. The skipahead strand begins execution at the next instruction (or binary translated version thereof) executed in program order after reaching the end of the trace containing the fork.skip uop. For terminal traces ending with a conditional or indirect branch, in some embodiments, the skipahead strand starts at a dynamically determined target of the branch. In some usage scenarios and/or embodiments, the system selects the fork target dynamically via a trace predictor and/or branch predictor. In scenarios where the terminal trace ends with an unconditional branch and/or the strandware ends the trace in the middle of a basic block, the starting point of the skipahead strand is determined when the terminal trace is generated.

In FIG. 2, fork.skip uop 211 in parent strand 200 has created a successor strand 201, illustrated in the right column executing as strand ID 22 on core 2. The successor strand starts after some delay due to inter-core communication latency (illustrated as three cycles). The successor strand then begins executing the trace corresponding to the fork target address.

The fork.skip uop encodes a propagate set (illustrated as propagated-archreg-set field dashed-box element 212) that specifies a bitmap of architectural registers to be written by the terminal trace of the parent (other architectural registers are not modified by the trace). Execution of the successor strand stalls on the first read of an architectural register that is a member of the propagate set, unless the successor strand has previously written the register, so the successor will subsequently read its own private version of the register in lieu of the not yet propagated version of the parent.

With respect to the terminal trace of the parent strand, the uop format includes a mechanism to indicate that results of the uop are to propagate to the successor strand. In some embodiments, a VLIW bundle includes one or more “propagate” bits, each associated with one or more uops of the bundle. When the strandware schedules and optimizes a terminal trace for skipahead, the strandware sets the propagate bit of each uop if and only if the uop is the final uop (relative to the original program order of the uops of the trace) to write to a particular architectural register A, thus producing a live-out value. In some embodiments, the original program order is different from the execution order of a scheduled VLIW trace, and in other embodiments, the orders are identical.

When a uop targeting architectural register A executes and the propagate bit of the uop is set, the uop output value V is transmitted to the successor strand S (of the current strand). Conceptually, the value V is then written into the register file of strand S so that future attempts in S to read architectural register A receive the value V until a uop in strand S overwrites architectural register A with a new (locally produced) value. If successor strand S had been stalled while attempting to read live-in architectural register A, strand S is then unblocked to continue executing now that the value V has arrived. The parent strand, in some circumstances, propagates particular live-out architectural registers before the successor strand reads the registers. The particular registers are written into the register file of the successor strand (e.g. any of Register Files 194A.1-194A.4) in the background and are not a source of stalls. The architectural registers that are not members of the propagate set are not be written by the terminal trace, and the successor strand thus inherits the values of the registers at the start of the terminal trace. The values are propagated in the background into the register file associated with the successor strand. The successor strand stalls if an inherited architectural register is not propagated before the successor strand accesses the register.

FIG. 2 illustrates an example of the propagation. After fork uop 211 creates successor strand 201, the first three bundles 280, 281, and 282 of the first trace of the successor strand execute (respectively in cycles 3, 4, and 5), since the bundles are not dependent on any live-in registers (e.g. live-out registers from the parent strand terminal trace). However, when bundle 283 attempts to execute during cycle 6, the bundle stalls, since the bundle is dependent on live-in architectural registers % rbx and % rbp that the terminal trace of the parent strand has not yet generated. In cycle 9, bundle 269 of the parent strand terminal trace computes the live-out values of % rbx and % rbp via uops 215 and 216, respectively, and propagates the values to the successor strand. The values arrive at the core executing successor strand 201 several cycles later (e.g. corresponding to inter-core communication latency), and in cycle 12, (successor strand) trace 201 wakes up and executes bundles 284 and 285. When the next bundle of the successor strand attempts to read % rdi, a value is unavailable. The parent strand generates the live-out value of % rdi in cycle 13 via uop 217 and propagates the value to successor strand 201 for arrival in cycle 16. Then bundle 286 wakes up and executes in cycle 16. The figure illustrates background propagation of some live-out architectural registers (such as % rsp and % xmmh0, propagated by uops 213 and 214 respectively) before the registers are read by the successor strand.

In some circumstances, the parent strand attempts to overwrite an architectural register the successor strand is to inherit before a value for the register has been transmitted to the successor strand. In some embodiments, interlock hardware prevents the parent from overwriting an old value of a register until the old value is en route to the successor. In some circumstances, the successor overwrites a live-in architectural register without reading the register before the parent has propagated a corresponding live-out value to the successor. In some embodiments, the successor notifies the parent that the successor is no longer waiting for the propagated register value, since the successor has a more up-to-date (locally generated) value.

Various mechanisms are used in various embodiments to propagate register values from the parent strand to the successor strand. Some embodiments use different propagation mechanisms and/or priorities for live-out propagated registers versus inherited registers. In some embodiments, the register values are not copied. Instead, the successor strand uses a copy-on-write register caching mechanism to retrieve inherited and live-out values from the parent strand on-demand. The mechanism uses a copy-on-write function to prevent inherited values from overwriting by the parent before communication to the successor, and to suppress propagation when the successor no longer depends on a value. In some embodiments, a register renaming mechanism is used to avoid copying actual values. The fork operation copies a rename table of the parent strand to the successor strand (instead of copying values), and both strands share one or more physical registers until one strand overwrites one or more of the physical registers.

### Speculative Strand Threading (SST)

### SST Overview

The strandware partitions target software into a plurality of independently executable strands, to enable increased parallelism, performance, or both. The strandware and hardware operate collectively to dynamically profile target software to detect relatively large regions of control and data flow of the target software that have relatively few or no inter-dependencies between the regions. The strandware transforms each region into a strand by inserting a fork point at the start, and a join point/fork target at the end. Strands are program ordered with respect to each other, and execute independently.

In various embodiments, the hardware and strandware continue to monitor and refine the selection of fork and join points based on real-time feedback from observing and profiling dynamic control flow and data dependencies, enabling, in some usage scenarios, one or more of improved performance, improved adaptability, and improved/robustness.

### Strand Scope Identification

In some speculative multithreading embodiments, a fork point produces two parallel strands: a new successor strand that starts executing at the fork target address in the target software and the existing parent strand that continues executing (in the target software) after the fork point. A trace predictor and/or branch predictor select the fork target dynamically.

After a fork, the scope (e.g. lifetime) of the parent strand includes all code executed after the fork operation until the execution path of the parent strand reaches the initial start address of the successor strand, or some other limits are reached. A strandware strand profiling subsystem derives the scope of each strand.

If the strandware identifies a loop for parallelization, both the fork point (where a fork operation is executed) and fork target (where the successor strand begins execution) refer to the top of the loop and branches that terminate the loop limit the scope of the parent. In a scenario of a conditional branch at the end of a loop (that jumps to the top of the loop for the next iteration), the terminating direction of the branch is not taken.

The strandware uses heuristics to identify terminating branches and directions based on output of various compilers (such as GCC, ICC, Microsoft Visual Studio, Sun Studio, PathScale Compiler Suite, and PGI). The compilers generate roughly equivalent control flow idioms for a given instruction set (e.g. x86). For example, bounds of a loop are identified by finding any taken branch that skips to the basic block immediately after the basic block(s) that jump back to the top of the loop for the next iteration. Other terminating branches include return instructions and unconditional branches to addresses after the last basic block in the loop body.

Consider call-return forks where the fork origin point is immediately before a function call (e.g. prior to an x86 CALL instruction) and the target address is immediately after the call instruction (i.e. at the return address). The scope of the parent strand is determined only by the body of the function call, and is terminated by the intersection of the parent strand with the return address. Dynamically, function calls relatively frequently return to the call site unless the program executes erroneous code or an exception handler.

There are other relatively more generalized types of forks, such as when the fork is performed before beginning a relatively large block of code and the fork target is after the end of the block. Internal branches within the block (e.g. the scope of the parent strand) optionally exit the block and branch into the successor scope. The strandware identifies and instruments the internal branches as terminating branches. In various embodiments, various structured programming cases (e.g. for loops, calls, and returns) are processed as part of a more generalized control flow analysis technique.

In some embodiments, terminating branches are be found by executing a depth first traversal through the basic blocks on the control flow graph, starting at the basic block containing the fork origin and recursively following both taken and not-taken exits to every branch. In usage scenarios, locating the terminating branches is complicated by a variety of situations (e.g. branches not mapped into the address space, invalid or indeterminate branch targets, and other situations giving rise to difficult to determine control flow changes). However, the strandware preserves correctness of target software, even if the strandware does not detect all terminating branches. Accommodating undetected terminal branches enables strandware operation even when the strandware lacks any knowledge of high-level program structure information (e.g. source code).

The strandware identifies and instruments traces containing each terminating branch by injecting a conditional kill uop into the traces. Execution of the conditional kill uop aborts all successor strands of the strand executing the kill uop if a condition specified by the kill uop evaluates to true. Execution of an alternative type of conditional kill uop aborts the strand executing the kill uop and all successor strands of same if the strand executing the kill uop is speculative (see the section “Bridge Traces and Live-In Register Prediction” located elsewhere herein).

If a terminating basic block ends with a branch uop, such as “br.cc R,R2”, (where registers R1 and R2 are compared and the branch is taken only if comparison condition cc is true), then the strandware injects a matching kill uop, such as “kill.cc R1,R2,T”. The kill uop specifies cc, R1, and R2 that match the branch.

### Nested Strands

To maintain fully deterministic execution of target software, in some embodiments the strandware uses a strictly program ordered non-nested speculative multithreading model, where a parent strand P has at most one successor strand S1 (with optional recursion of S1 to a successor S2, and so forth). Some embodiments enable a strand to have a plurality of successor prefetch strands (optionally in addition to a single non-prefetch successor strand), since the prefetch strands make no modifications to architectural state.

In some programs, P encounters another fork point before joining S1. To preserve deterministic behavior, the hardware suppresses any fork points in a parent strand when a successor exists. To ensure that P does eventually join S1, the strandware uses heuristics and hardware-implemented functions (e.g. timeouts) to detect and abort runaway strands, and then re-analyze the target software for terminal branches to reduce or prevent future occurrences.

Each kill uop is marked with a strand scope identifier, so if a fork point for a strand is suppressed, then any kill uops for the strand scope are also suppressed.

To perform recursive functions, each strand maintains a private fork nesting counter (initialized to zero when the strand is created) that is incremented when a fork is suppressed. When the hardware processes a kill uop, the kill uop only aborts a strand if the nesting counter of the strand is zero, otherwise the nesting counter is decremented and the strand is not aborted.

### Candidate Strand Selection

In some usage scenarios, some loops are good candidates for speculative multithreading (with one or a plurality of iterations per strand). In some embodiments, the hardware includes profiling logic units and the strandware synthesizes instrumentation code (that interacts with the profiling logic units) for determining which loops are appropriate for breaking into parallel strands.

Each backward (looping) branch in target software has a unique target physical address P that the strandware uses for identification and profiling. The hardware filters out loops that are determined to be too small to optimize productively, by tracking total cycles and iterations and using strandware tunable thresholds for total cycles and iterations (e.g. the hardware filters out loops with less than 256 cycles per iteration). The hardware allocates a Loop Profile Counter (LPC), indexed by P, to relatively larger loops. The LPC holds total cycles, iterations, confidence estimators, and other information relevant to determining if the loop is a good candidate for optimization. The strandware periodically inspects the LPCs to identify strand candidates. The strandware manages LPCs. In various embodiments, one or more of the LPCs are cached in hardware and/or stored in memory.

Similar techniques are used in some embodiments for other types of candidate strands, such as called functions. For calls, a set of call profiling counters (CPCs) are optionally used to record various statistics, e.g. the number of cycles spent in the called function, which registers were modified, the most likely return values, and other information potentially useful in determining if the strand is a good candidate for optimization.

### Strand Nesting Graph Construction

In some embodiments, the strandware dynamically constructs one or a more data structures representing relationships between regions of the target code as a strands or candidate strands known to the strandware. The strandware uses the structures to track nesting of strands inside each other. For example, for a plurality of nested loops (e.g. inner loops and outer loops), a strand having a function body optionally contains a nested function call (the function call containing a strand) or one or more loops. In some embodiments, the strandware represents nesting relationships as a tree or graph data structure.

In some embodiments, the strandware adds instrumentation code to translated uops (such as maintained in a translation cache), to update the strand nesting data structures at runtime as the translated uops are executed. In some embodiments, the hardware includes logic to assist strandware with dynamic discovery of strand nesting relationships.

Based on strand nesting hierarchy as represented in the strand nesting data structures, the strandware uses heuristics to select relatively more effective regions of code to transform into strands, and the strandware instruments each selected strand for further profiling as described below. In some embodiments, the heuristics include one or more techniques to select an appropriate strand from nested inner and outer loops.

### Instrumentation for Profiling

Based on the fork origin, the fork target, and the set of terminating branches and respective directions, the strandware injects instrumentation into the uop-based translation of the target software (e.g. as stored in a translation cache) to form a complete and properly scoped strand. In some embodiments, the strandware injects a profiling fork into the trace or trace(s) containing the basic block at the fork origin point. The profiling fork instructs the hardware to create a profiling strand, such as described in the sections “Parent Strand Profiling” and “Successor Strand Profiling” located elsewhere herein. The strandware identifies and instruments the trace or trace(s) containing each terminating branch, such as described in section “Strand Scope Identification” located elsewhere herein.

### Parent Strand Profiling

After instrumentation for profiling, the next time the trace containing the fork point is executed, the hardware creates a profiling strand as a successor strand of a parent strand. The profiling strand blocks until the parent strand intersects with the starting address of the profiling strand. Then the profiling strand begins executing, while the parent strand blocks. When the profiling strand completes (e.g. via an intersection, a terminating branch, or another fork), the parent unblocks and joins the profiling strand. The hardware invokes the strandware to complete strand construction as described following.

After performing a profiling fork, the hardware enters a special profiling mode to execute the remainder of the parent strand.

For each occurrence of certain events in the parent strand, the strandware arranges for a Strand Execution Profiling Record (SEPR) to be written into a memory buffer allocated by Strandware to hold SEPRs generated by the parent strand. In some preferred embodiments, an SEPR is written whenever certain types of memory accesses (loads or stores) are performed. In some embodiments, additional SEPRs are written to enable the strandware to later reconstruct the exact code sequence executed by the strand, for instance by recording the execution of basic blocks, traces, control flow changes, or similar data.

### Successor Strand Profiling

A parent strand blocks when completed, while the successor (profiling) strand executes and register and memory dependencies are identified. With respect to register dependencies, as the successor strand executes, the hardware updates a per-strand bitmask when the hardware first reads an architectural register, prior to the hardware writing over the register in the successor strand. The bitmask represents the live-outs from the parent strand that are used as live-ins for the successor strand.

With respect to memory dependencies, in some embodiments transactional memory versioning systems enable speculation within the data cache. When a strand loads data, the hardware makes a reservation on the memory location at cache line (or byte level) granularity. The hardware tracks the reservations by updating a bitmap of which bytes (or chunks of multiple bytes) speculative strands have loaded. The hardware optionally tracks metadata, e.g. a list of which specific future strands have loaded a memory location. The hardware stores the bitmap with the cache line and/or in a separate structure.

The data for the load comes from the latest of all strands that have written that address earlier than the loading strand (in program order). In some circumstances, the earliest strand is the architectural strand (e.g., when the line is clean). In some circumstances, the earliest strand is a speculative strand (e.g. when the line is dirty) that is earlier than the loading strand.

When a strand writes to a cache line, the hardware checks if any future strands have reservations on the cache line. If so, then the hardware has detected a cross-strand alias, and the hardware aborts the future strand and any later strands. Alternatively, the hardware notifies the strandware of the cross-strand alias, to enable the strandware to implement a flexible software defined policy for aborting strands.

Since the hardware serializes a profiling strand to begin execution after the parent strand has completed, cross-strand aliasing does not occur; the hardware executes all loads and stores in program order (with respect to the strand order, not necessarily the order of uops within a strand), and therefore the reservation hardware is free for other purposes. While in profiling mode, in some embodiments the system (e.g. any combination of the hardware and strandware) uses the memory reservation hardware to analyze cross-strand memory forwarding.

The scope of a profiling strand is finite for a loop: the profiling ends when execution reaches the top of the loop. Other types of forks, such as a call/return fork or a generalized fork, have potentially unlimited scope, and hence the system uses heuristics to limit the scope of the profiling strand. When the hardware detects that the profiling strand has completed execution, the parent strand is unblocked and the strandware begins to execute a join handler that constructs instrumentation needed for a fully speculative strand.

### Dataflow Graph Construction via SEPR Processing

Using the program ordered SEPR data that the system previously collected, the strandware builds up a data flow graph (DFG), starting with the live-outs of the parent as root nodes.

As described elsewhere herein, while executing the parent strand, the hardware maintains a list of program ordered SEPRs as a record of which traces and/or basic blocks the hardware executed, as well as the cache tags and index metadata of relevant loads and stores. Using the record, the strandware decodes each basic block in each executed trace into a stream of program ordered uops. To construct the DFG, uop operands are converted into pointers to earlier uops in program order, using a register renaming table.

To track memory dependencies, the strandware maintains a memory renaming table that maps cache locations to the latest store operation to write to an address. Thus, loads and stores selectively specify a previous store as a source operand. The strandware uses the cache locations recorded in the SEPRs, with the memory renaming table, to include memory dependencies in the DFG.

At the conclusion of the process, all uops executed in the parent strand have been incorporated into a dataflow graph, with the root nodes (live outs) of the graph pointed to by the current register renaming table and the memory renaming table.

### Bridge Traces and Live-In Register Prediction

The live-in set of a speculative successor strand (e.g. final live-outs of the parent) are predicted from the architectural register values that existed when the parent strand forked. The strandware searches the dynamic DFG, depth first, from each live-out (both registers and memory) to produce a subset of generating uops. The union of all the subsets, in program order, is the live-out generating set.

The strandware creates a bridge trace that starts with the architectural register and memory values at the fork point in the parent strand, and only includes the live-out generating set used to predict final live-outs (as indicated by the live-in bitmask of the successor speculative strand). The bridge trace also copies any live-out register predictions to a memory buffer. Later the system uses the copies to detect mispredictions.

When a trace forks to a speculative strand, the strandware sets up the new strand to begin execution at the bridge trace, rather than the first uop of the speculative strand. In addition to handling register dependencies, the bridge trace converts any terminating branches (and related uops that calculate the branch condition) into uops that abort the speculative strand. Last, the bridge trace sets up various internal registers for the strand, such as pointers to the predicted memory value list, deferral list, and an unconditional branch, to the start of the speculative strand.

### Bridge Trace Optimizations

Once the strandware has constructed the bridge trace, the strandware attempts to reduce or minimize the length using various dynamic optimization techniques. Some idioms such as spilling and filling registers or using many calls and returns in a strand sometimes result in a register being repeatedly loaded and stored from the stack, without being changed. Similarly, a stack pointer or other register is sometimes repeatedly incremented or decremented, while in aggregate, the dependency chain is equivalent to the addition of a constant.

The strandware recognizes at least some of the idioms and patterns and optimizes away the dependency chains into relatively few or fewer operations. For instance, the strandware uses def-store-load-use short-circuiting, where a load reading data from a previous store is speculatively replaced by the value of the store (the speculation is verified at the join point along with the register and memory predictions).

If the strandware is unable to reduce the bridge trace to a predetermined or programmable length, the strandware abandons the optimizing of the strand. The abandoning occurs in various circumstances, such as when there are true cross-strand register dependencies, or when a live-out is computed relatively late in the parent strand and consumed relatively early in the successor strand (thus resulting in a relatively long dependency chain).

### Memory Value Prediction

For some strands, the bridge trace predicts memory values. The strandware uses the load reservation data collected during execution of the successor profiling strand (such as described in section “Successor Strand Profiling” located elsewhere herein) to determine which memory locations were written by the parent strand and subsequently read by the successor profiling strand (sometimes referred to as cross-strand forwarding). In some embodiments, the strandware directly accesses the hardware data cache tags and metadata to build a list of cache locations that were forwarded across strands.

The strandware looks up each cache location affected by cross-strand forwarding in the memory renaming table for the DFG. The table points to the most recent store uop (in program order) to write to the location. Then the strandware builds the sub-graph of uops necessary to generate the value of the store uop (e.g. using a depth first search). The strandware includes uops into the bridge trace along with any other uops used to generate register value predictions.

The store uop in a bridge trace decouples the store in the parent strand from subsequent successor strands (the successor strands instead load the prediction from the bridge trace). Last, the strandware copies information about each predicted store into a per-strand store prediction validation list that is later compared with the actual store values to validate the speculation. In various embodiments, the information includes one or more of the physical address of the store, the value stored, and the mask of bytes written by the store (or alternatively, the size in bytes and offset of the store).

### Join Handler Trace

Each speculative strand constructed by the strandware has a matching bridge trace and join handler trace. The join handler trace validates all register or memory value predictions made by the bridge trace that were actually used (e.g., unused predictions are ignored). Whenever a parent strand ends (such as via an intersection with the successor, a terminating branch, or other event), the hardware redirects the successor strand to begin executing the join handler defined for the parent strand.

For each register value prediction used, the join handler reads the predicted value from the memory buffer (such as described in section “Bridge Traces and Live-In Register Prediction” located elsewhere herein), and compares the predicted value with the live-out value from the parent strand. The hardware includes “see through” register read and memory load functions that enable a join trace to read state (e.g. registers and memory) of the join trace and corresponding state of the parent strand for comparison. Some embodiments only compare registers read by the successor strand.

Similarly, to validate memory value predictions, the join trace iterates through the list of predicted stores that were used (in various embodiments, including one or more of a physical address, value, and bytemask for each entry), and compares each predicted store value with the locally produced live-out value of the parent strand at the same physical address. If the system detects any mismatches, then the system aborts the successor strand and the parent strand continues past the join point as if the system had not forked the successor.

If the join is successful, the system discards the parent strand and the successor strand becomes the new architectural strand for the corresponding VCPU.

### OTHER EMBODIMENT INFORMATION

### Figure Overview

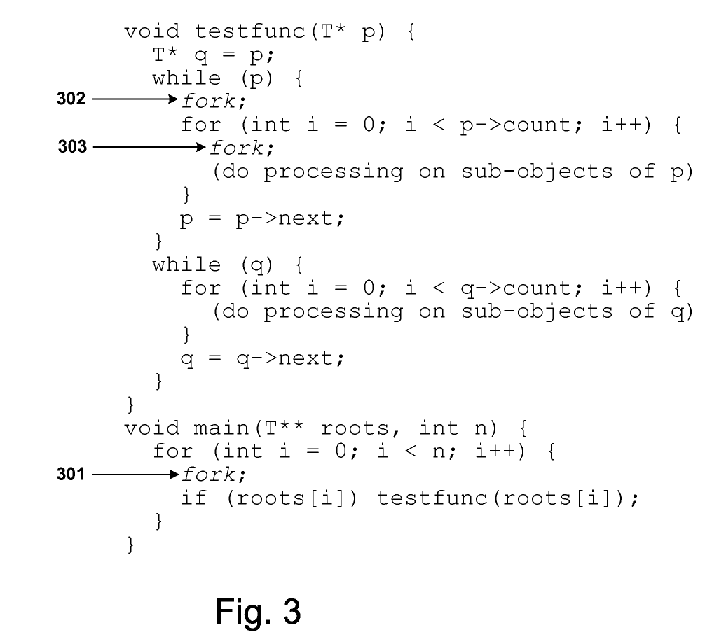

FIG. 3 illustrates an example of nested loops, expressed in C code.

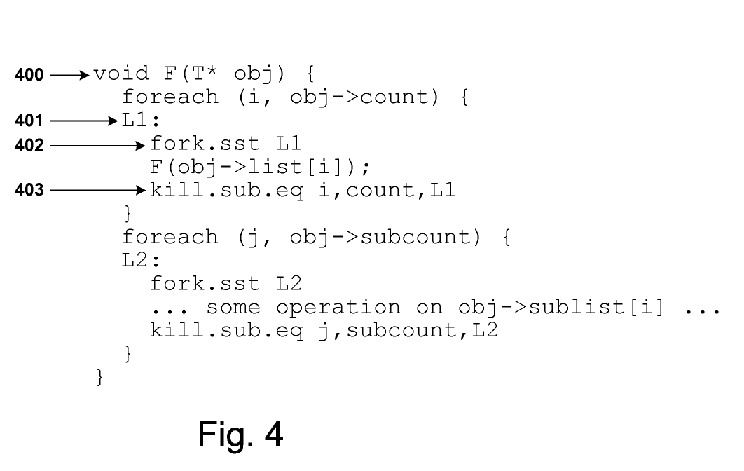

FIG. 4 illustrates a recursive function example.

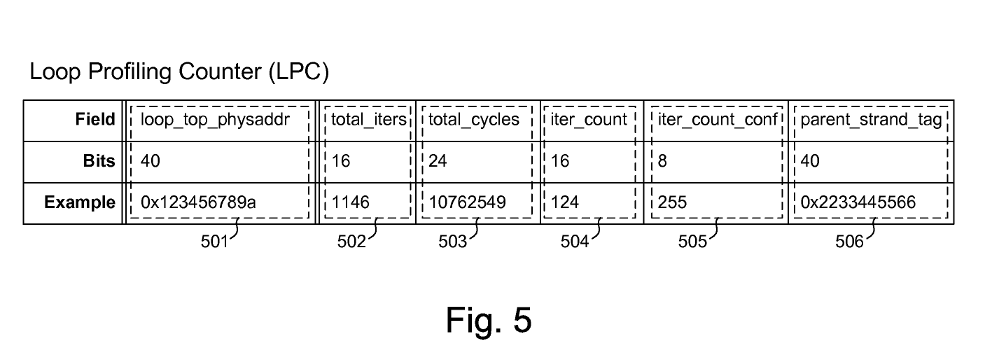

FIG. 5 illustrates an embodiment of a Loop Profiling Counter (LPC).

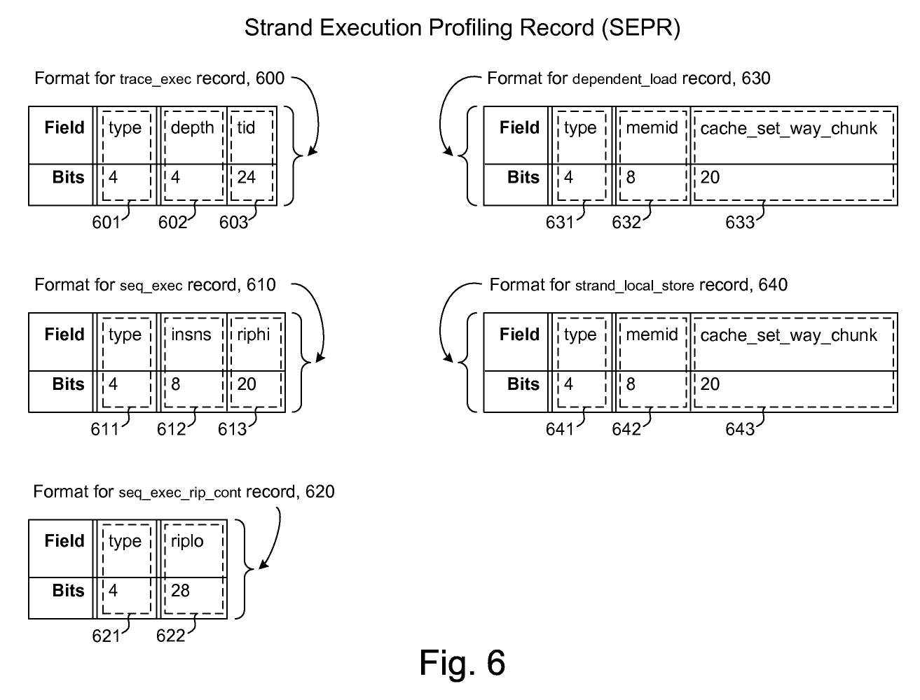

FIG. 6 illustrates an embodiment of a Strand Execution Profiling Record (SEPR).

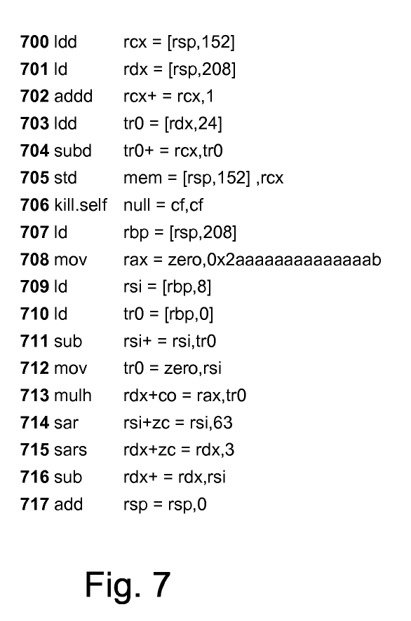

FIG. 7 illustrates an example of uops to generate a predicted parent strand live-out set, as reconstructed from SEPRs.

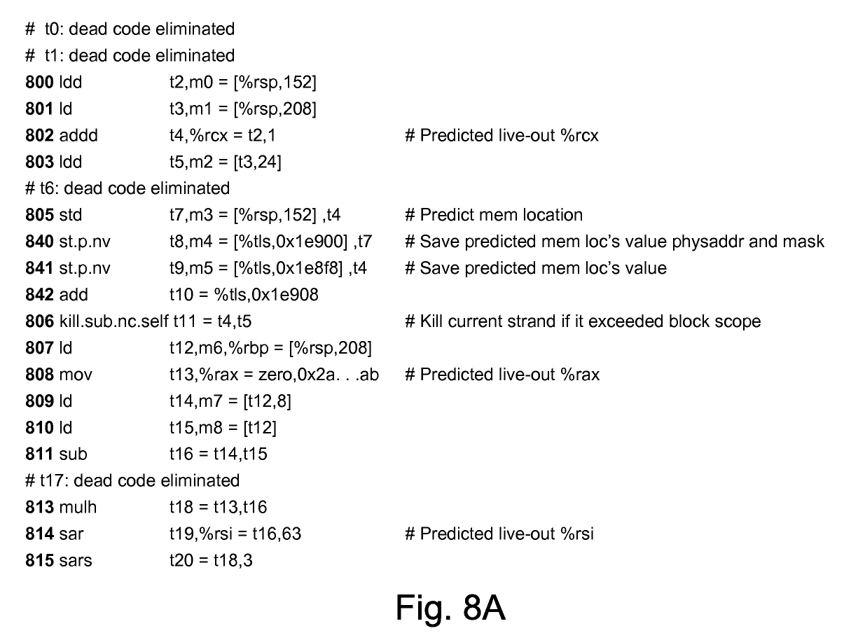

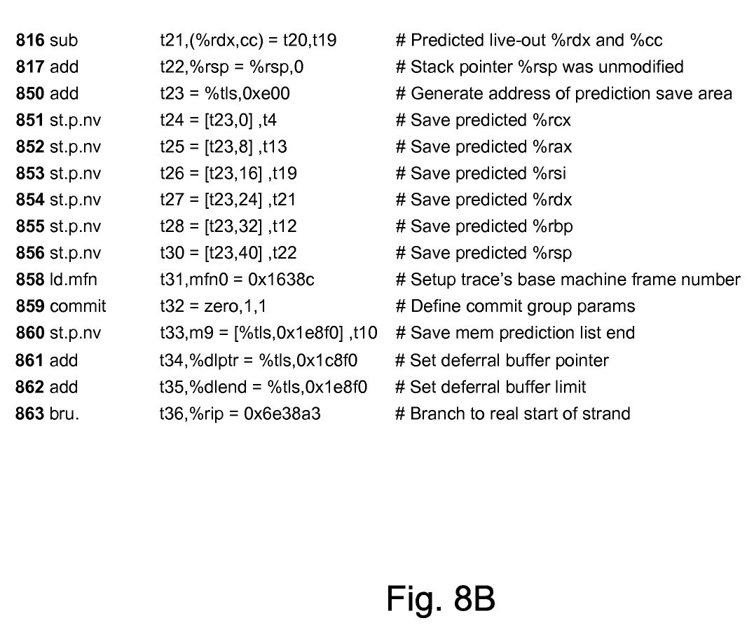

FIGS. 8A and 8B collectively illustrate an example of an optimized bridge trace (in SSA-form) corresponding to the live-out predicting uops illustrated in FIG. 7. Sometimes the description refers to FIGS. 8A and 8B collectively as FIG. 8.

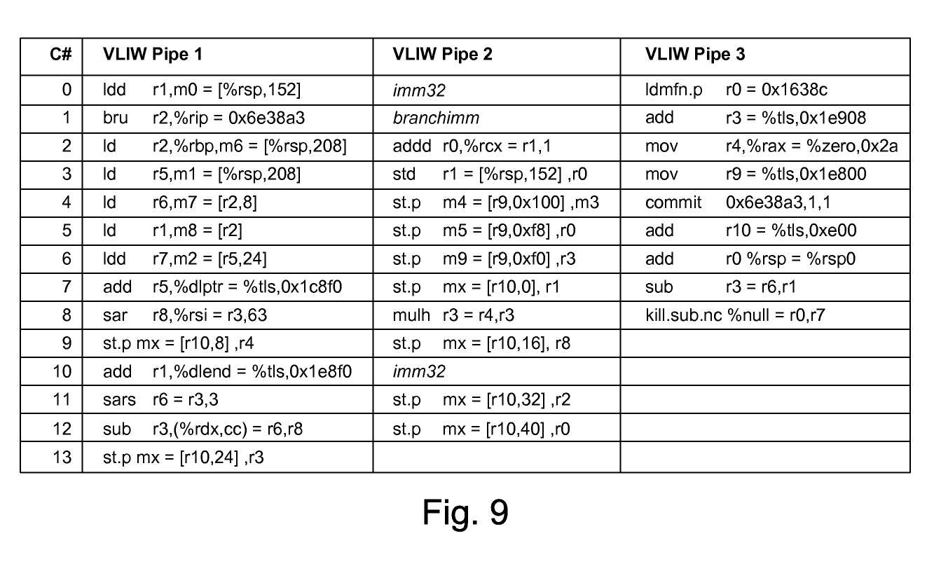

FIG. 9 illustrates an example of a scheduled VLIW bridge trace corresponding to the bridge trace illustrated in FIGS. 8A and 8B.

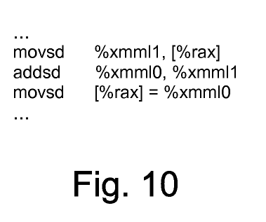

FIG. 10 illustrates an example of a read-modify-write idiom in target (e.g. x86) code.

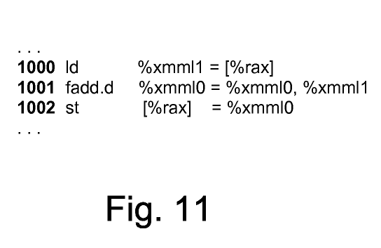

FIG. 11 illustrates an example of a read-modify-write idiom in uops corresponding to target code.

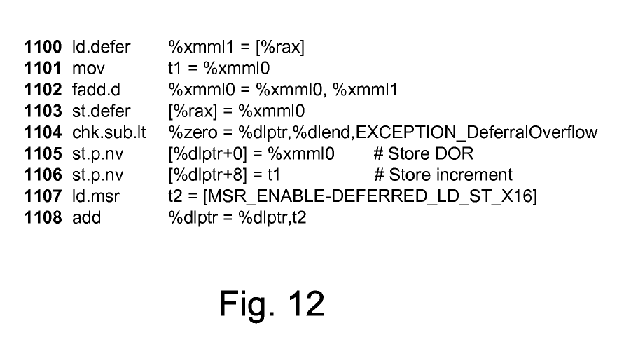

FIG. 12 illustrates an example of read-modify-write code instrumented for deferral.

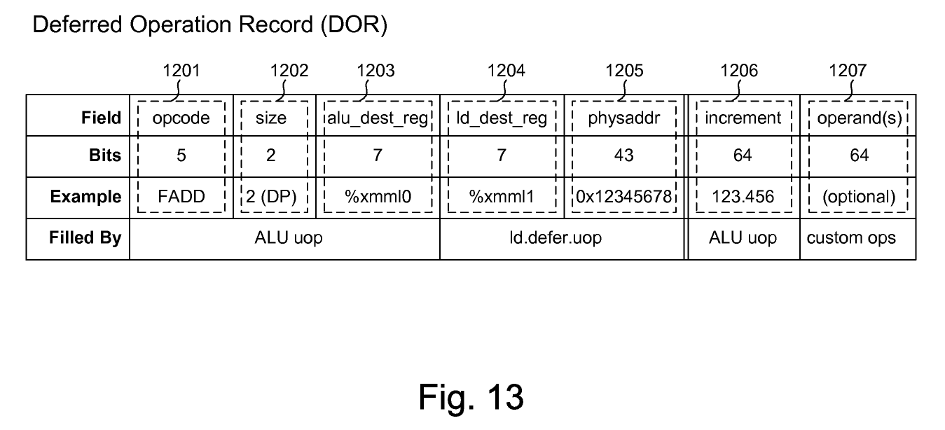

FIG. 13 illustrates an embodiment of a deferred operation record (DOR).

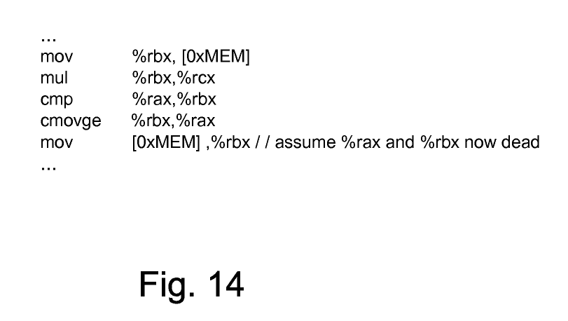

FIG. 14 illustrates an example code sequence for “mem=max(mem* % rcx, % rax)”).

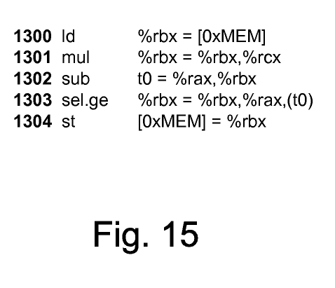

FIG. 15 illustrates an example uop sequence translated from the code sequence of FIG. 14.

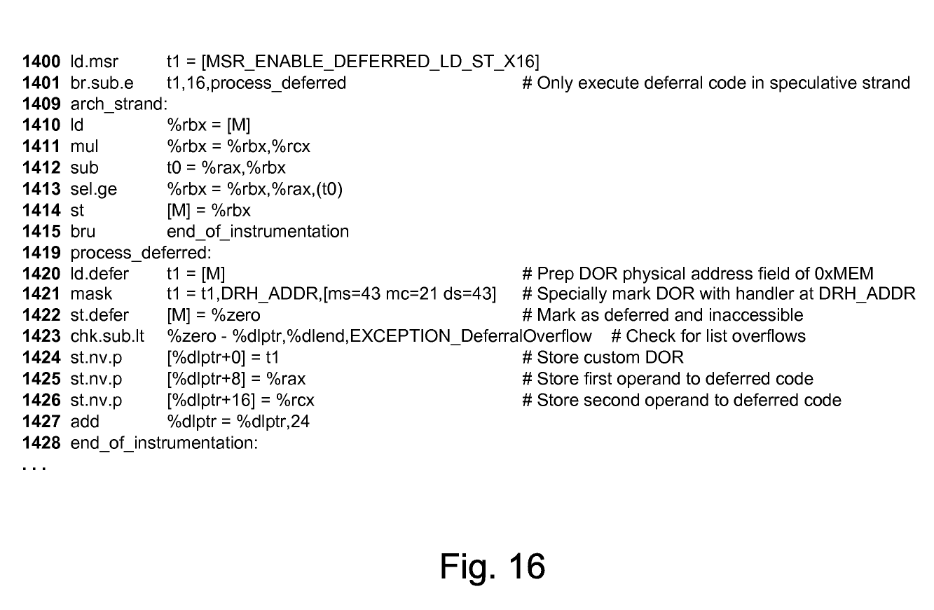

FIG. 16 illustrates an example of a deferred instrumented version of the uop sequence of FIG. 15.

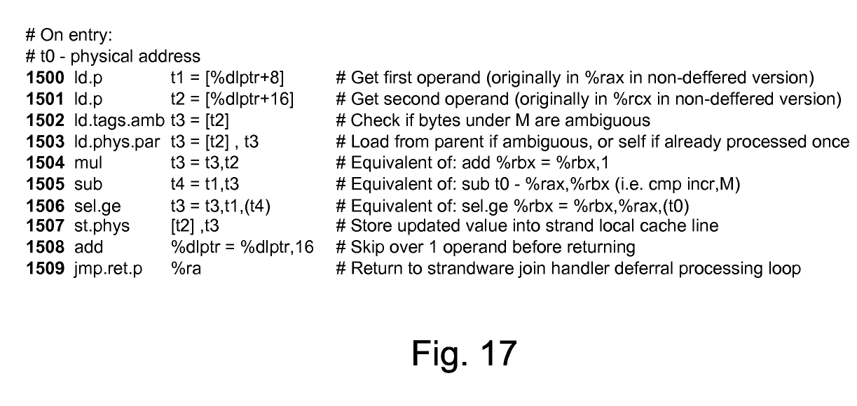

FIG. 17 illustrates an example of a custom deferral resolution handler for the instrumented sequence of FIG. 16.

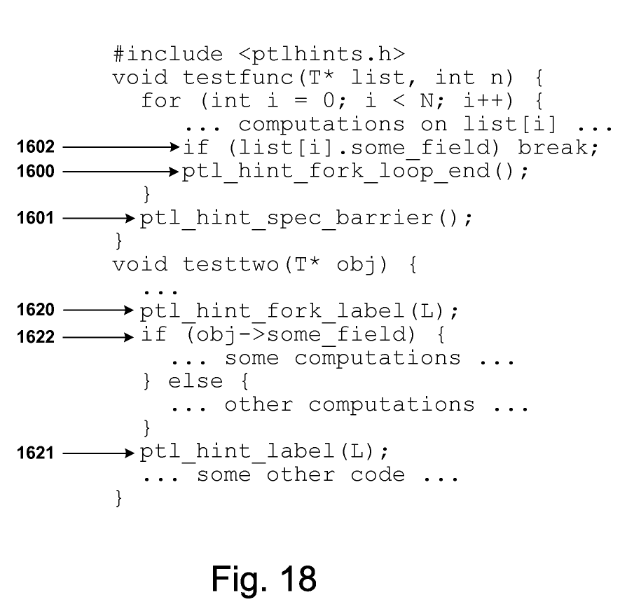

FIG. 18 illustrates an example of C/C++ code using explicit hints.

### Example Implementation Techniques

In some embodiments, various combinations of all or portions of operations performed by a strand-enabled microprocessor (such as either of Strand-Enabled Microprocessors 2001.1-2001.2 of FIG. 1A), a hardware layer (such as Hardware Layer 190 of FIG. 1C), and portions of a processor, microprocessor, system-on-a-chip, application-specific-integrated-circuit, hardware accelerator, or other circuitry providing all or portions of the aforementioned operations, are specified by descriptions compatible with processing by a computer system. The specification is in accordance with various descriptions, such as hardware description languages, circuit descriptions, netlist descriptions, mask descriptions, or layout descriptions. Example descriptions include: Verilog, VHDL, SPICE, SPICE variants such as PSpice, IBIS, LEF, DEF, GDS-II, OASIS, or other descriptions. In various embodiments the processing includes any combination of interpretation, compilation, simulation, and synthesis to produce, to verify, or to specify logic and/or circuitry suitable for inclusion on one or more integrated circuits. Each integrated circuit, according to various embodiments, is designed and/or manufactured according to a variety of techniques. The techniques include a programmable technique (such as a field or mask programmable gate array integrated circuit), a semi-custom technique (such as a wholly or partially cell-based integrated circuit), and a full-custom technique (such as an integrated circuit that is substantially specialized), any combination thereof, or any other technique compatible with design and/or manufacturing of integrated circuits.

In some embodiments, various combinations of all or portions of operations associated with or performed by strandware (such as Strandware Layers 110A and 110B of FIGS. 1B and 1C, respectively), are performed by execution and/or interpretation of one or more program instructions, by interpretation and/or compiling of one or more source and/or script language statements, or by execution of binary instructions produced by compiling, translating, and/or interpreting information expressed in statements of programming and/or scripting languages. In various embodiments, various combinations of all or portions of the execution and the interpretation of the program instructions is via one or more of direct hardware execution, interpretation, microcode, and firmware techniques. The statements are compatible with any standard programming or scripting language (such as C, C++, Fortran, Pascal, Ada, Java. VBscript, and Shell). One or more of the program instructions, the language statements, or the binary instructions, are optionally stored on one or more computer readable storage medium elements (for example as all or portions of Strandware Image 2004 of FIG. 1A). In various embodiments some, all, or various portions of the program instructions are realized as one or more functions, routines, sub-routines, in-line routines, procedures, macros, or portions thereof.

### CONCLUSION

Certain choices have been made in the description merely for convenience in preparing the text and drawings and unless there is an indication to the contrary the choices should not be construed per se as conveying additional information regarding structure or operation of the embodiments described. Examples of the choices include: the particular organization or assignment of the designations used for the figure numbering and the particular organization or assignment of the element identifiers (i.e., the callouts or numerical designators) used to identify and reference the features and elements of the embodiments.

The words “includes” or “including” are specifically intended to be construed as abstractions describing logical sets of open-ended scope and are not meant to convey physical containment unless explicitly followed by the word “within.”

Although the foregoing embodiments have been described in some detail for purposes of clarity of description and understanding, the invention is not limited to the details provided. There are many embodiments of the invention. The disclosed embodiments are exemplary and not restrictive.

It will be understood that many variations in construction, arrangement, and use are possible consistent with the description, and are within the scope of the claims of the issued patent. For example, interconnect and function-unit bit-widths, clock speeds, and the type of technology used are variable according to various embodiments in each component block. The names given to interconnect and logic are merely exemplary, and should not be construed as limiting the concepts described. The order and arrangement of flowchart and flow diagram process, action, and function elements are variable according to various embodiments. Also, unless specifically stated to the contrary, value ranges specified, maximum and minimum values used, or other particular specifications (such as ISA, number of cycles, and the number of entries or stages in registers and buffers), are merely those of the described embodiments, are expected to track improvements and changes in implementation technology, and should not be construed as limitations.

Functionally equivalent techniques known in the art are employable instead of those described to implement various components, subsystems, functions, operations, routines, sub-routines, in-line routines, procedures, macros, or portions thereof. It is also understood that many functional aspects of embodiments are realizable selectively in either hardware (i.e., generally dedicated circuitry) or software (i.e., via some manner of programmed controller or processor), as a function of embodiment dependent design constraints and technology trends of faster processing (facilitating migration of functions previously in hardware into software) and higher integration density (facilitating migration of functions previously in software into hardware). Specific variations in various embodiments include, but are not limited to: differences in partitioning; different form factors and configurations; use of different operating systems and other system software; use of different interface standards, network protocols, or communication links; and other variations to be expected when implementing the concepts described herein in accordance with the unique engineering and business constraints of a particular application.

The embodiments have been described with detail and environmental context well beyond that required for a minimal implementation of many aspects of the embodiments described. Those of ordinary skill in the art will recognize that some embodiments omit disclosed components or features without altering the basic cooperation among the remaining elements. It is thus understood that much of the details disclosed are not required to implement various aspects of the embodiments described. To the extent that the remaining elements are distinguishable from the prior art, components and features that are omitted are not limiting on the concepts described herein.

All such variations in design are insubstantial changes over the teachings conveyed by the described embodiments. It is also understood that the embodiments described herein have broad applicability to other applications, and are not limited to the particular application or industry of the described embodiments. The invention is thus to be construed as including all possible modifications and variations encompassed within the scope of the claims of the issued patent.

What is claimed is:

1. A method comprising:
dynamically constructing a dynamic-profiling-directed strand-partitioned-thread-portion of at least one of one or more threads, wherein the dynamically constructing is implemented at least in part via at least one of the one or more threads, wherein the strand-partitioned-thread-portion of each strand-partitioned thread comprises a respective plurality of strand images;
strand-based processing the one or more threads; and
wherein for each strand-partitioned thread processed, simultaneously executing an intra-thread plurality of strands corresponding to two or more of the respective plurality of strand images of the strand-partitioned thread.

2. The method of claim 1, wherein the strand images are translation-cache-stored bit-instance-groups respectively corresponding to the strand-partitioned-thread-portions.

3. The method of claim 1, wherein the at least one of the one or more threads is a thread of executable instructions.

4. The method of claim 1, wherein the dynamically constructing partitions at least one of the strand-partitioned threads after the at least one of the strand-partitioned threads has begun executing.

5. The method of claim 1, wherein the dynamically constructing partitions at least one of the strand-partitioned threads based at least in part on dynamic profiling information collected in response to execution of the at least one of the strand-partitioned threads.

6. The method of claim 1, wherein the dynamically constructing is ongoing with respect to the strand-based processing.

7. The method of claim 1, further comprising:
wherein for each strand-partitioned thread processed, the intra-thread plurality of strands comprises an architectural strand of the strand-partitioned thread and at least one or more successor strands of the strand-partitioned thread, each successor strand being younger than the architectural strand of the strand-partitioned thread;
wherein for each strand-partitioned thread processed, the architectural strand updates an architectural strand context comprising architectural state of the strand-partitioned thread; and
wherein for each strand-partitioned thread processed, each successor strand updates a respective successor strand context comprising a speculative version of the architectural state of the strand-partitioned thread.

8. The method of claim 1, further comprising simultaneously executing an inter-thread plurality of strands comprising an architectural strand associated with each strand-partitioned thread processed, each architectural strand updating respective architectural strand context comprising respective architectural state.

9. The method of claim 1, wherein the one or more threads comprise all or any portion of applications executing in user mode and to an operating system kernel executing in privileged mode.

10. The method of claim 1, wherein the one or more threads comprise all or any portion of a virtual machine monitor and to one or more operating system kernels managed by the virtual machine monitor.

11. The method of claim 1, wherein the one or more threads are in accordance with at least a first instruction set architecture and the respective pluralities of strand images are in accordance with a second instruction set architecture.

12. The method of claim 1, wherein the dynamically constructing is automatic and unobservable to the one or more threads.

13. The method of claim 1, further comprising executing each of the simultaneously executing intra-thread plurality of strands on respective cores of a microprocessor.

14. The method of claim 1, further comprising executing each of the simultaneously executing intra-thread plurality of strands on respective functional units of a microprocessor.

15. A system comprising:
strand construction means for dynamically constructing a dynamic-profiling-directed strand-partitioned-thread-portion of at least one of one or more threads, wherein the strand construction means is implemented at least in part via at least one of the one or more threads, and wherein the strand-partitioned-thread-portion of each strand-partitioned thread comprises a respective plurality of strand images;
execution means for strand-based processing of the one or more threads; and
wherein for each strand-partitioned thread processed, the execution means enables simultaneous execution of an intra-thread plurality of strands corresponding to two or more of the respective plurality of strand images of the strand-partitioned thread.

16. The system of claim 15, wherein for each strand-partitioned thread processed, the intra-thread plurality of strands comprises an architectural strand of the strand-partitioned thread and at least one or more successor strands of the strand-partitioned thread, the architectural strand updates an architectural strand context comprising architectural state of the strand-partitioned thread, each successor strand is younger than the architectural strand of the strand-partitioned thread, and each successor strand updates a respective successor strand context comprising a speculative version of the architectural state of the strand-partitioned thread.

17. The system of claim 15, wherein the execution means further enables simultaneous execution of an inter-thread plurality of strands comprising an architectural strand associated with each strand-partitioned thread processed, each architectural strand updating respective architectural strand context comprising respective architectural state.

18. The system of claim 17,
wherein for each strand-partitioned thread processed, the intra-thread plurality of strands comprises the architectural strand of the strand-partitioned thread and at least one or more successor strands of the strand-partitioned thread, each successor strand is younger than the architectural strand of the strand-partitioned thread, and each successor strand updates a respective successor strand context comprising a speculative version of the architectural state of the strand-partitioned thread; and
wherein the strand contexts are held in one or more dedicated context stores within a microprocessor.

19. The system of claim 15, wherein each of the simultaneously executing intra-thread plurality of strands is executed on respective cores of a microprocessor.

20. The system of claim 15, wherein each of the simultaneously executing intra-thread plurality of strands is executed on respective function units of a microprocessor.

21. The system of claim 15, wherein at least parts of the strand construction means are implemented using one or more of executable code and microcode of a microprocessor.

22. The system of claim 21, wherein at least portions of the one or more of executable code and microcode are maintained in one or more non-volatile-storage devices.

23. The system of claim 15, further comprising:
memory comprising one or more DRAM devices; and
wherein the strand construction means is allocated portions of the memory in support of the constructing of each strand-partitioned-thread-portion.

24. The system of claim 15, further comprising:
uop decoder logic enabled to decode at least one type of strand creation uop and at least one type of strand destruction uop.

25. The system of claim 16, further comprising:
context storage dedicated to storing the strand contexts; and
strand join logic coupled to the context storage and enabled to perform, for at least one processed strand-partitioned thread of the one or more threads, hardware-assisted merging of a plurality of the strand contexts.

26. The system of claim 16, further comprising:
context storage dedicated to storing the strand contexts; and
strand fork logic coupled to the context storage and enabled to perform, for at least one processed strand-partitioned thread of the one or more threads, hardware-assisted copying of at least portions of the context of the architectural strand into corresponding portions of the context of at least one of the successor strands.

27. The system of claim 16, further comprising:
a transactional memory comprising dedicated transactional memory storage and dedicated transactional memory control logic, the transactional memory being enabled to perform, for at least one processed strand-partitioned thread of the one or more threads, hardware-assisted versioning of memory data, wherein multiple data versions are maintained corresponding to each of a plurality of memory locations, wherein for each of the plurality of memory locations a first version of the versions corresponds to the architectural strand and at least at second version of the versions respectively corresponds to at least one of the successor strands.

28. The system of claim 15, further comprising:
analysis means for identifying one or more dependencies corresponding to respective cross strand operations occurring between the plurality of simultaneously executing intra-thread strands and aliasing to one or more respective memory locations;
deferral means for removing the one or more dependencies via replacing the respective cross strand operations with one or more respective deferred operations;
resolution means for evaluating each of the deferred operations performed by the plurality of simultaneously executing intra-thread strands;
wherein the identifying and the replacing are enabled to operate dynamically at least during the processing of each strand-partitioned thread processed; and
wherein with respect to execution of each strand-partitioned thread processed, results realized from the processing via the plurality of simultaneously executing intra-thread strands are identical to architecture-specified results for strictly sequential processing.
